(19) United States
(12) Patent Application Publication
(10) Pub. No.: US 2026/0111297 A1
(43) Pub. Date: Apr. 23, 2026

(54) PROACTIVE ANOMALY MITIGATION VIA NUDGE GENERATION

(71) Applicant: ADP, Inc., Roseland, NJ (US)

(72) Inventors: Xiaojing Wang, Alpharetta, GA (US); Kishore Bangali, Parsippany, NJ (US); Fan Yang, Bayonne, NJ (US); Shamanth Vishwas Hanchate, Parsippany, NJ (US); Linxuan Jiang, Cumming, GA (US); Shanshan Wang, Scotch Plains, NJ (US); Saravanan Palanisamy, Alpharetta, GA (US)

(73) Assignee: ADP, Inc., Roseland, NJ (US)

(21) Appl. No.: 19/360,401

(22) Filed: Oct. 16, 2025

Related U.S. Application Data
(60) Provisional application No. 63/708,693, filed on Oct. 17, 2024.

(51) Int. Cl. G06F 11/07

(52) U.S. Cl. CPC G06F 11/0757; G06F 11/0718

(57) ABSTRACT

System and methods of this technology can provide a framework using machine learning based message generator. The framework can retrieve elapsed times according to computing devices executing an application. Once the elapsed times are retrieved, the framework can generate a total elapsed time that can indicate an average amount of time captured by the at least one computing devices. The framework can make a determination based on the total elapsed time and a threshold elapsed time. The threshold elapsed time can be generated from data associated with previous months, years, days, among other time periods. Upon determining that the total elapsed time is higher than the threshold elapsed time, the framework can generate instructions to display the metrics associated with the total elapsed time, on another computing device.

### CROSS REFERENCE TO RELATED APPLICATIONS

This application claims benefit and priority under 35 U.S.C. § 119 to U.S. Provisional Patent Application No. filed 63/708,693, filed Oct. 17, 2024, which is hereby incorporated herein in its entirety.

### TECHNICAL FIELD

This application is directed to computing system technology, and, more particularly, to a computing system that uses machine learning to identify anomalies associated with computing devices.

### BACKGROUND

As the use of computing systems increases, providing messages to the computing systems during an optimal time and determining the messages to provide become more complex. In this manner, it can be challenging to reduce computing resources from wasted messages transmitted to the computing system, reduce utilization while generating the messages during non-optimal times, and determine parameters to start message generation for each computing system.

### SUMMARY

Aspects of the technical solution are directed to a framework to generate messages, determine which computing devices are to display the messages, and an optimal time to for the computing devices to present the messages. The framework can allow for an engine (e.g., machine learning model) to use one or more parameters to generate a message specific to the respective computing device. For example, due to the increased use of the computing devices, it can be challenging to determine, identify, or otherwise generate messages during optimal times associated with each computing device or computing system upon detection of an anomaly in a total elapsed time. Constantly generating and transmitting messages for computing system can result in excess computing resource utilization, increase memory utilization, and waste messages that are not displayed at the optimal times.

System and methods of this technology can provide a framework using machine learning based message generator. The framework can retrieve elapsed times according to computing devices executing an application. Once the elapsed times are retrieved, the framework can generate a total elapsed time that can indicate an average amount of time captured by the computing devices. The framework can make a determination based on the total elapsed time and a threshold elapsed time. The threshold elapsed time can be generated from data associated with previous months, years, days, among other time periods. Upon determining that the total elapsed time is higher than the threshold elapsed time, the framework can generate instructions to display the metrics associated with the total elapsed time, on another computing device.

An aspect of this application can be directed to computing system that can include one or more processors coupled with memory. The one or more processors The one or more processors can retrieve a plurality of clock times according to a plurality of computing devices executing an application during a first time. The one or more processors can generate a global clock time during the first time based on each clock time in the plurality of clock times associated with each computing device executing the application. The one or more processors can determine that the global clock time during the first time satisfies a threshold clock time during a second time. The threshold clock time can be generated by executing the computing operation on a plurality of global clock times during the second time that is preceding the first time. Each global clock time of the plurality of global clock time can correspond at least one computing device of the plurality of computing devices executing the application. The one or more processors can generate instructions for transmission to at least one administrative computing device. The instructions can be configured to cause the administrative computing device to display metrics indicating one or more parameters associated with the at least one computing device causing an increase in the global clock time.

An aspect of this application can be directed to a computing system that includes one or more processors coupled with memory. The one or more processors can retrieve, from a database at a time period, a plurality of elapsed times corresponding to a plurality of computing devices executing an instance of an application. Each elapsed time can be based on detection, at a prior time period, of an absence of at least one computing device executing a predetermined action within the instance of the application. The one or more processors can generate, via a computing operation, a total elapsed time for the time period based on the plurality of elapsed times. The one or more processors can identify, via the computing operation, a threshold elapsed time based on a historic elapsed time at a historic time period and one or more parameters causing an increase in the historic elapsed time at the at least one computing device from the database. The historic time period can be preceding the time period. The one or more processors can, responsive to the total elapsed time being greater than or equal to the threshold elapsed time, determine, via execution of a machine learning model, an instruction for transmission at a time interval established for each computing device based on the one or more parameters. The one or more processors can transmit, to the at least one computing device at the time interval, the instruction to perform the predetermined action, the instruction configured to cause the at least one computing device to display a notification indicating each of the one or more parameters causing the increase in the total elapsed time and causing the absence of the predetermined action.

An aspect of this application can be directed to a method. The method can be performed by one or more processors, coupled with memory. The method can include retrieving, by one or more processors from a database at a time period, a plurality of elapsed times corresponding to a plurality of computing devices executing an instance of an application. Each elapsed time can be based on detection, at a prior time period, of an absence of at least one computing device executing a predetermined action within the instance of the application. The method can include generating, by the one or more processors via a computing operation, a total elapsed time for the time period based on the plurality of elapsed times. The method can include identifying, by the one or more processors via the computing operation, a threshold elapsed time based on a historic elapsed time at a historic time period and one or more parameters causing an increase in the historic elapsed time at the at least one computing device from the database. The historic time period preceding the time period. The method can include, responsive to the total elapsed time being greater than or equal to the threshold elapsed time, determining, by the one or more processors via execution of a machine learning model, an instruction for transmission at a time interval established for each computing device based on the one or more parameters. The method can include transmitting, by the one or more processors to the at least one computing device, the instruction to perform the predetermined action. The instruction can be configured to cause the at least one computing device to display a notification indicating each of the one or more parameters causing the increase in the total elapsed time and causing the absence in the predetermined action.

An aspect of this application can be directed to a method. The method can be performed by one or more processors, coupled with memory. The method can include retrieving, by one or more processors from a database, a plurality of clock times according to a plurality of computing devices executing an application during a first time. The method can include generating, by the one or more processors via a computing operation, a global clock time during the first time based on each clock time in the plurality of clock times associated with each computing device executing the application. The method can include determining, by the one or more processors, that the global clock time during the first time satisfies a threshold clock time during a second time. The threshold clock time can be generated by executing the computing operation on a plurality of global clock times during the second time that is preceding the first time. Each global clock time of the plurality of global clock time can correspond to at least one computing device of the plurality of computing devices executing the application. In response to the global clock time during the first time being greater than the threshold clock time during the second time, the method can include generating, by the one or more processors, instructions for transmission to at least one administrative computing device. The instructions can be configured to cause the administrative computing device to display metrics indicating one or more parameters associated with the at least one computing device causing an increase in the global clock time.

An aspect of this application can be directed to a non-transitory computer-readable medium that stores processor-executable instructions that, when executed by one or more processors, cause the one or more processors to retrieve, from a database at a time period, a plurality of elapsed times corresponding to a plurality of computing devices executing an instance of an application. Each elapsed time based on detection, at a prior time period, of an absence of at least one computing device executing a predetermined action within the instance of the application. The one or more processors can generate, via a computing operation, a total elapsed time for the time period based on the plurality of elapsed times. The one or more processors can identify, via the computing operation, a threshold elapsed time based on a historic elapsed time at a historic time period and one or more parameters causing an increase in the historic elapsed time at the at least one computing device from the database. The historic time period can be preceding the time period. The one or more processors can, responsive to the total elapsed time being greater than or equal to the threshold elapsed time, determine, via execution of a machine learning model, an instruction for transmission at a time interval established for each computing device based on the one or more parameters. The one or more processors can transmit, to the at least one computing device at the time interval, the instruction to perform the predetermined action, the instruction configured to cause the at least one computing device to display a notification indicating each of the one or more parameters causing the increase in the total elapsed time and causing the absence of the predetermined action.

An aspect of this application can be directed to a non-transitory computer-readable medium that stores processor-executable instructions that, when executed by one or more processors, cause the one or more processors to retrieve a plurality of clock times according to a plurality of computing devices executing an application during a first time. The one or more processors can generate a global clock time during the first time based on each clock time in the plurality of clock times associated with each computing device executing the application. The one or more processors can determine that the global clock time during the first time satisfies a threshold clock time during a second time. The threshold clock time can be generated by executing the computing operation on a plurality of global clock times during the second time that is preceding the first time. Each global clock time of the plurality of global clock time can correspond at least one computing device of the plurality of computing devices executing the application. The one or more processors can generate instructions for transmission to at least one administrative computing device. The instructions can be configured to cause the administrative computing device to display metrics indicating one or more parameters associated with the at least one computing device causing an increase in the global clock time.

These and other aspects and implementations are discussed in detail below. The foregoing information and the following detailed description include illustrative examples of various aspects and implementations and provide an overview or framework for understanding the nature and character of the claimed aspects and implementations. The drawings provide illustrations and a further understanding of the various aspects and implementations and are incorporated in and constitute a part of this specification. The foregoing information and the following detailed description and drawings include illustrative examples and should not be considered as limiting.

### BRIEF DESCRIPTION OF THE DRAWINGS

Aspects of the present technology are described in the detailed description which follows, in reference to the noted plurality of drawings by way of non-limiting examples of exemplary embodiments of the present application.

FIG. 1 is an illustrative example of a system for a framework for message generation according to an illustrative embodiment;

FIG. 2 is an illustrative example of a system level architecture of the framework, according to an illustrative embodiment;

FIG. 3 is an illustrative example of the system level architecture of the framework with templates for message generation, according to an illustrative embodiment;

FIG. 4 is an illustrative example of a service level view of the framework according to an illustrative embodiment;

FIG. 5 is an illustrative example of a component level view of a Nudge Engine within the framework, according to an illustrative embodiment;

FIG. 6 is an illustrative example of a platform general flow diagram of a processors for the framework according to an illustrative embodiment;

FIG. 7 is an illustrative example of a flow diagram of uses cases for the framework according to an illustrative embodiment;

FIG. 8 is an illustrative example of the nudge engine according to an illustrative embodiment;

FIG. 9 is an illustrative example of metrics displayed to a computing device according to an illustrative embodiment;

FIG. 10 is an illustrative example of a process taken by the nudge engine according to an illustrative embodiment;

FIGS. 11-12 are illustrative examples of various statistics associated with the framework according to an illustrative embodiment;

FIG. 13 is an illustrative example of various statistics associated with a use case of the framework, according to an illustrative embodiment;

FIG. 14 is an illustrative example of a graph associated with a use case according to an illustrative embodiment;

FIG. 15 is an illustrative example of total elapsed times according to an illustrative embodiment;

FIG. 16 is an illustrative example of testing for the nudge engine according to an illustrative embodiment;

FIG. 17 is an illustrative example of a process for the nudge engine according to an illustrative embodiment;

FIGS. 18-23 are an illustrative example of various statistics associated with the use case of the framework, according to an illustrative embodiment;

FIG. 24 is an illustrative example of data used by the nudge engine of the framework, according to an illustrative embodiment;

FIGS. 25-26 are illustrative example of various statistics associated with the use case of the framework according to an illustrative embodiment;

FIGS. 27-30 are illustrative example of messages generated by the nudge engine case of the framework according to an illustrative embodiment;

FIGS. 31-32 are illustrative example of various statistics associated with the use case of the framework according to an illustrative embodiment; and

FIG. 33 is a flowchart for a method for a framework for message generation, according to an illustrative embodiment.

### DETAILED DESCRIPTION

Aspects of the technical solution are directed to a framework to generate messages, determine which computing devices are to display the messages, and an optimal time to for the computing devices to present the messages. The framework can allow for an engine (e.g., machine learning model) to use one or more parameters to generate a message specific to the respective computing device. For example, due to the increased use of the computing devices, it can be challenging to determine, identify, or otherwise generate messages during optimal times associated with each computing device or computing system. Constantly generating and transmitting messages for computing system can result in excess computing resource utilization, increase memory utilization, and waste messages that are not displayed at the optimal times.

System and methods of this technology can provide a framework using machine learning based message generator. The framework can retrieve elapsed times according to computing devices executing an application. Once the elapsed times are retrieved, the framework can generate a total elapsed time that can indicate an average amount of time captured by the computing devices. The framework can make a determination based on the total elapsed time and a threshold elapsed time. The threshold elapsed time can be generated from data associated with previous months, years, days, among other time periods. Upon determining that the total elapsed time is higher than the threshold elapsed time, the framework can generate instructions to display the metrics associated with the total elapsed time, on another computing device. Using the system and methods described herein, the framework can generate message in accordance with a request at an optimal time for a respective user of a computing device in response to the detection of an anomaly.

The systems and methods described herein further address technical challenges associated with anomaly detection such as executing periodic batch jobs or queries that compare static data which causes latency spikes and high CPU usage. The systems and methods described herein can retrieve an elapsed time corresponding to a computing device that is executing an application associated with an entity. The systems and methods described herein can use the elapsed time to control when the detection of an action or operation is executable by the computing device. By using the elapsed time, the systems and methods can analyze the computing devices over less busy periods thereby saving computing resources and improving on responsiveness in real time.

The system and methods can resolve anomalies by avoiding the manual assembly or configure requests or non-uniform messages at an endpoint which cause inconsistent data formats and higher CPU cost for request generation. In resolving, the systems and methods can determine an instruction for presentation to the computing device based on pre-defined schemas and dynamically formulated templates. In this manner, the requests can be generated in memory with minimal computational overhead and reducing payload size of any messages transmitted via the network.

The systems and methods described here can eliminate the need to transform results of detecting the absence of the action at the computing device. Entities may include remediation systems that include a plurality of conversion steps which cause latency, CPU throughput, and increased CPU utilization. By using prompts based on dynamic templates, the systems and methods described herein can generate and produce schema based and compliant ready messages at the point of creation thereby reducing the intermediate conversion stages and improving the timely deliver of the messages.

By using the systems and methods described herein, entities can avoid reliance on analysis engines that load excessive datasets into memory. These datasets can include redundant or unnecessary fields that are irrelevant to the needs of the entity. For example, an entity may include a dataset that include ten fields, however two of the ten fields are usable by the computing devices of the entity. By including such datasets, entities or databases associated with entities suffer from increased memory consumption and overhead from garbage collection. By selecting templates from a library based on placeholder fields within the template, the systems and method can reduce the size of queries, conserve memory, and reduce data access latency when providing prompts or messages.

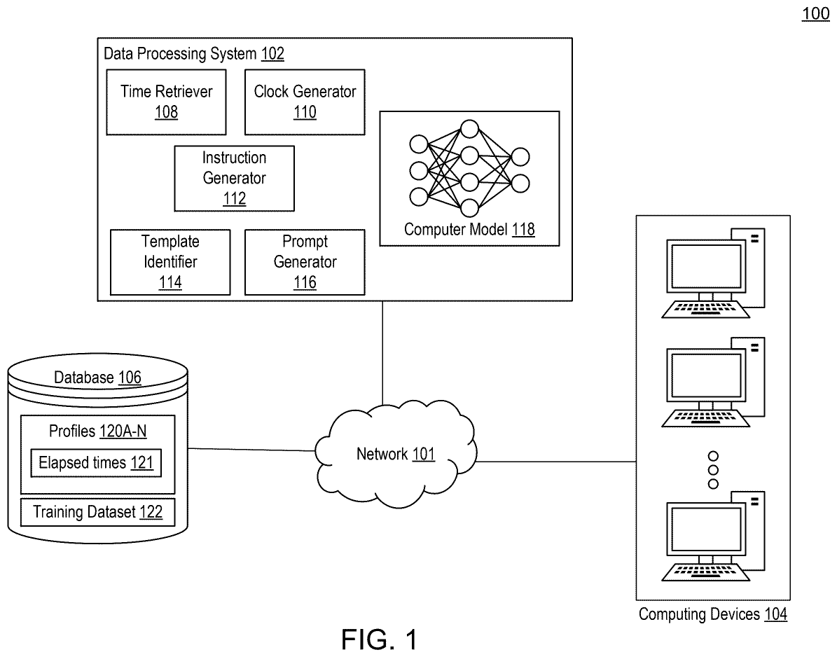

FIG. 1 is an illustrative example of a system 100 for a framework for message generation. The system 100 can include at least one data processing system 102, computing devices 104 (generally referred to as a “computing devices 104“or as” administrative computing devices 104”), and a database 106. The above-mentioned components may be connected to each other through a network 101. The examples of the network 101 may include, but are not limited to, private or public Local-Area Network (LAN), Wireless Local-Area Network (WLAN), Metropolitan-Area Network (MAN), Wide-Area Network (WAN), and the Internet. The network 101 may include both wired and wireless communications according to one or more standards and/or via one or more transport mediums.

The communication over the network 101 may be performed in accordance with various communication protocols such as Transmission Control Protocol and Internet Protocol (TCP/IP), User Datagram Protocol (UDP), and IEEE communication protocols. In one example, the network 101 may include wireless communications according to Bluetooth specification sets, or another standard or proprietary wireless communication protocol. In another example, the network 101 may also include communications over a cellular network, including, e.g., a GSM (Total System for Mobile Communications), CDMA (Code Division Multiple Access), EDGE (Enhanced Data for Total Evolution) network.

The system 100 is not confined to the components described herein and may include additional or alternate components, not shown for brevity, which are to be considered within the scope of the embodiments described herein.

The computing devices 104 of the system 100 may include hardware and software components configured to perform the various processes and tasks described herein, including one or more processors or software comprising machine-executable instructions executed by the one or more processors. Non-limiting examples of such computing devices 104 of the system 100 include server computers, laptop computers, desktop computers, tablet computers, and smartphone mobile devices, among others. The computing devices 104 may execute webserver software for hosting one or more webpages according to web-related or data-communications protocols and computing languages.

The system 100 can include at least one database 106. The database 106 can store various types of data related to data sources, entity data, records, computing device 104 information, among others. The data processing system 102 can access the database 106 when the one or more components of the data processing system 102 requires information or data to execute the framework for message generation. The database 106 can include profiles 120A-N (generally referred to as “profiles 120” or a “profile 120”) and a training dataset 122. In operation, one or more computing devices 104 can transmit a request to retrieve elapsed times 121 associated with a respective computing device 104 from the database 106. The database 106 can include one or more hardware memory devices to store binary data, digital data, or the like. The database 106 can include one or more electrical components, electronic components, programmable electronic components, reprogrammable electronic components, integrated circuits, semiconductor devices, flip flops, arithmetic units, or the like. The database 106 can include at least one of a non-volatile memory device, a solid-state memory device, a flash memory device, and a NAND memory device. The database 106 can include one or more addressable memory regions disposed on one or more physical memory arrays. A physical memory array can include a NAND gate array disposed on, for example, at least one of a particular semiconductor device, integrated circuit device, or printed circuit board device.

The data processing system 102 of the system 100 can include at least one time retriever 108, at least one clock generator 110, at least one instruction generator 112, at least one template identifier 114, at least one prompt generator 116, and at least one computer model 118 (e.g., Temporal Powered Durable Execution Engine). Each of the components (e.g., time retriever 108, clock generator 110, instruction generator 112, template identifier 114, prompt generator 116) of the data processing system 102 can execute one or more instructions associated with the data processing system 102. The components can include an electronic processor, an integrated circuit, or the like including one or more of digital logic, analog logic, digital sensors, analog sensors, communication buses, volatile memory, nonvolatile memory, and the like. The components can include, but are not limited to, at least one microcontroller unit (MCU), microprocessor unit (MPU), central processing unit (CPU), graphics processing unit (GPU), physics processing unit (PPU), embedded controller (EC), or the like. The data processing system 102 can include one or more communication bus controllers to effect communication between the processors and the other elements of the data processing system 102.

In further detail, the time retriever 108 can retrieve, receive, or otherwise identify elapsed times 121 from the profile 120. The clock generator 110 can generate, create, or otherwise determine a total clock for the computing devices 104. The instruction generator 112 can generator, transmit, or otherwise determine instructions for display at the administrative computing device 104. The template identifier 114 can identify, extract, or otherwise determine a template for the computing device 104 according to the profile 120. The prompt generator 116 can generate, determine, or otherwise identify a prompt based on the template. The computer model 118 can generate, output, or otherwise create a message for display at the computing device 104.

The computer model 118 can be any artificial intelligence or machine learning algorithm or model configured to generate a historic elapsed time, a schedule for the computing devices 104, or messages for the computing devices 104. The computer model 118 can be, for example, a structure based data model, such as gradient boosted decision trees, random forests, logistic regression, neural networks, risk models, among other algorithms.

Still referring to FIG. 1, the time retriever 108 can retrieve, identify, or otherwise receive a plurality of profiles 120 from the database 106. Each profile 120 can correspond to a respective computing device 104 in a plurality of computing devices 104. The data processing system 102 can generate the profile 120 upon establishing a connection with the computing device 104. The profile 120 can include various characteristics associated with the computing device 104, such as screen time, how often the computer is charging, time spent on applications or web-domains, most visited applications/web domains, working hours, update history, among other characteristics. Using each of the characteristics, the data processing system 102 (e.g., clock generator 110) can generate the profile 120 for the computing device 104.

The profiles 120 can be stored, housed, or otherwise maintained within the database 106. The profiles 120 can be a data structure that is configured to store each of the various characteristics associated with the respective computing device 104. The data structure can be one or more of a linked list, array, abstract data table, a map, a graph, and a key-value pair among other data structures. Each data structure can include a field that maintains an association with the computing device 104. The association can represent a linkage, binding, or correlation between the profile 120 and the computing device 104. The clock generator 110 can generate the profile 120 in response to a request that includes information to establish the profile 120. The clock generator 110 can receive the request from the computing device 104, one or more computing devices 104, or an entity hosting each of the computing devices 104.

Within each profile, the time retriever 108 can retrieve, identify, or otherwise receive a plurality of elapsed times 121 from each profile 120 in the plurality of profiles. The elapsed time 121 of the profile 120 can be based on the computing device 104 executing an application corresponding to the entity. The application can include one or more tasks that the computing device 104 can complete during a time period (e.g., hours, days, months, weeks, years). The elapsed time 121 can correspond to a plurality of factors, such as the time spent on the application, a range of time corresponding to a frequency of executing the application (e.g., between 9 AM-5 PM), the days executing the application (e.g., Saturday, Sunday), the days from completing one or more actions within the application (e.g., action due on November 1 and it is currently October 20), a duration of an absence to complete the one or more actions (e.g., action due on November 1 and it is currently November 20), among other factors. Using the elapsed times 121, the data processing system 102 can determine anomalies associated with the computing devices 104. The anomalies can include but are not limited to invalid data, outdated data, missing data, discrepancies between the data within the profile 120 and rules associated with an entity, incorrect calculations (e.g., pay, wage, logging issues), compliance issues, event based anomalies, a failure of one or more tasks, and an absence of a predetermined action/operation among other anomalies. For example, an anomaly within the profile 120 can be missing a social security number associated with a user of the computing device 104.

The time retriever 108 can automatically retrieve the plurality of elapsed times 121 according to a frequency defined by an administrative device (e.g., computing device 104). The time retriever 108 can receive authorization credentials from the administrative device to configure the frequency. For example, the administrative device can provide a username and password, biometric authentication, single sign on (SSO), multifactor authentication, one-time code, among other authorization credentials to automatically configure the frequency of the extraction of the elapsed time 121. The frequency can be daily, weekly, bi-weekly, monthly, bi-monthly, quarterly, annually, among other frequencies to query the database 106 for the profiles 120. The time retriever 108 can manually query the database 106 for the profiles 120 based on a real time (or near real time) request from the administrative device. Upon reception of the address, the time retriever 108 can query the database 106 for the elapsed times 121.

The clock generator 110 can generate, create, or otherwise determine a total elapsed time based on each elapsed time in the plurality of elapsed times 121 upon retrieval of the elapsed times 121 for each profile in the plurality of profiles 120. The clock generator 110 can generate the total elapsed time based on each elapsed time 121 associated with each profile 120, by executing a computing operation, an algorithm, or other mathematical function. The total elapsed time can correspond to an average of the plurality of elapsed times 121. The clock generator 110 can generate the total elapsed time 121 according to one or more factors associated with the profile 120. For example, the clock generator 110 can generate the total elapsed time 121 for the computing devices 104 that completed a predefined action. In another example, the clock generator 110 can generate the total elapsed time 121 for the computing devices 104 that are missing at least on data field within the profile 120.

By generating the total elapsed time, the data processing system 102 can make determinations about each profile 120 associated with each computing device 104. For example, the data processing system 102 can compare the elapsed time 121 of a first computing device 104 with the total elapsed time. If the total elapsed time is less than the elapsed time 121 of the computing device 104, the data processing system 102 can determine, for example, that the computing device 104 is executing the applications associated with an entity for longer than normal, missing data for an extended period of time, failing complete a predetermined action, among other determinations. In some instances, the data processing system 102 can isolate one or more computing devices 104 with similar elapsed times 121 to form a group or subset of computing devices. In some instances, the clock generator 110 can generate a total elapsed time for the subset of computing devices 104. From here, the data processing system 102 can transmit the group of computing devices 104 and the total elapsed time of the group to the administrative computing device 104, as described herein.

The clock generator 110 can access the database 106 to retrieve data associated with the computing device 104. The data can be from within the profile 120 associated with the computing device (e.g., profile including the same IP address as the computing device 104). The database 106 can further include criteria for comparison against the data within the profile 120 that can indicate one or more parameters causing an increase in the total elapsed time. The criteria can be a rule, condition, or threshold that is automatically set by the clock generator 110 or set by an administrative computing device. The criteria can be set by logical comparison (e.g., if (value_from_device>threshold_value_frompolicy), then anomaly). For example, the criteria can be Days since last PTO>60, Payroll variance>$50 for given pay cycle, Float holiday balance+vacation balance above 80 hours, among other criteria. The one or more parameters can be the characteristics as defined within the profile 120, application, operational data, etc. The one or more parameters can be dynamic values that are specific to the respective computing device 104. For example, the one or more parameters can indicate that the days since last PTO is 80 days which is greater than the value defined in the criteria triggering an anomaly. The one or more parameters can correspond to or indicate payroll variance, address discrepancy, verification information, expiration risk, among other parameters.

The clock generator 110 can determine, identify, or otherwise indicate that the total elapsed time during the first time satisfies a threshold or historic elapsed time. The clock generator 110 can generate the threshold elapsed time based on a plurality of elapsed times (e.g., historic) that occurred prior to or is proceeding the time interval or time period. For example, the clock generator 110 can use the total elapsed times from October-December in the years 2020-2024 to generate the threshold elapsed time. In another example, the clock generator 110 can use the total elapsed times from each summer in the years 2015-2023 to generate the threshold elapsed time. In this manner, the data processing system 102 can use the threshold elapsed time to compare against the total elapsed time of the group or against each computing device 104 in the plurality of computing devices 104. In some examples, the data processing system 102 can perform the comparison between the threshold elapsed time and the total elapsed time according to the one or more parameters. During the comparison, the clock generator 110 can determine a delta between the total elapsed time and the threshold elapsed time. The clock generator 110 can identify anomalies associated with the total elapsed time based on the delta. For example, when the delta is larger than a threshold delta, the clock generator 110 can label the total elapsed time as an anomaly. In this context, the anomaly can indicate a deviation from the historical patterns associated with the historic elapsed time.

In response to the total elapsed time being greater than the threshold elapsed time, the instruction generator 112 can apply or execute the computer model 118 on the one or more parameters causing the increase in the total elapsed time. The computer model 118 can ingest each profile 120 corresponding to the computing devices 104. Once ingested, the computer model 118 can learn patterns and associations with parameters of the profile 120 causing the increase in the total elapsed time for each computing device 104. Based on the patterns, the computer model 118 can generate or determine an instruction for transmission to each computing device 104. In some instances, the computer model 118 can determine an instruction for the computing devices 104 within a group. In some instances, the computer model 118 can determine a plurality of instructions corresponding to the plurality of computing device 104. The computer model 118 can generate a schedule for transmission of the instruction or the instruction. The schedule can include a plurality of time intervals to provide the instruction to the computing device. The computer model 118 can establish the time intervals according to the one or more factors within the profile. For example, the computer model 118 can determine the instructions for transmission during the peak hours of a first computing device 104, whereas determine the instructions for transmission before the end of a quarterly review for a second computing device 104. In another example, the computer model 118 can determine the instructions for transmission during based on the geographic location of a subset of computing devices 104. In another example, the computer model 118 can determine the instructions for transmission when the data processing system 102 detects that the computing device is online (e.g., connected to a respective server). In this manner, the computer model 118 can intelligently and dynamically provide messages for each of the computing devices 104 to attempt to resolve the anomaly.

In some instances, the instruction generator 112 can indicate, monitor, or otherwise manage the administrative computing device and the profile of the computing devices to detect a modification to the information, fields, or data within the profile 120 for a respective computing device 104. The modification can occur via the application. For example, the administrative device can modify a wage associated with a profile 120 for the computing device 104. Based on the modification, the instruction generator 112 can execute the computer model 118 to resolve the anomaly in real time.

The instruction generator 112 can generate, transmit, or otherwise send instructions based on the execution of the computer model 118. The instruction generator 112 can generate the instructions in a format readable by the administrative computing device 104. For example, the instruction generator 112 can generate the instructions in a machine readable format or human readable format (e.g., HTML, JSON, XML, etc.) for the administrative computing device 104 or the plurality of computing devices 104. The instruction generator 112 can embed one or more parameters associated with at least one computing device 104 within the instruction. The one or more parameters can include factors causing the increase in the total elapsed time. For example, the one or more parameters can include, tasks completed through the application, the work hours of the computing device 104, the amount of pending tasks, among other factors causing the increase in total elapsed time.

The instruction generator 112 can transmit or send the instruction to at least one computing device 104 that is increasing the total elapsed time 121. The instruction can include control logic and content. The control logic can indicate the predetermined action that needs to be completed by the computing device (e.g., update SSN, submit a missing form, schedule PTO, correct an address). The content can be data or information needed for an action such as ID of the anomaly, the affected record, the parameters causing the delay, resolution steps based on the template, among other redate. For example, the instructions can include a phrase such as “Update employee legal address in HRIS to match verified record.” The instruction can indicate to the computing device 104 to perform the predetermined action or to resolve the absence of the action. The instruction can cause the computing device 104 to display a notification, flag, message, e-mail, web application pop-up, a banner alert within the application, among other forms of alerts displayed on the computing device 104. The alert can indicate each of the one or more parameters causing the increase in the elapsed time and the absence of the action.

The instruction generator 112 can transmit the instructions to the administrative computing device 104. Upon reception by the administrative computing device 104, the instructions can cause the computing device to display metrics indicating the one or more parameters causing the increase in total elapsed time. The metrics can be displayed by the instructions rendering a user interface on the computing device 104. The user interface can include a visualization tool such as tableau, Microsoft power bi, Qlik sense, QlikView, google data studio, looker studio, domo, Sisense, matplotlib, seaborn, dash, bokeh, ggplot2, d3.j s, chart.js, high charts, fusion charts, echarts, Kibana, Grafana, sas visual analytics, IBM Cognos analytics, spss visualization designer, yellowfin bi, Zoho analytics, datapine, periscope data, mode analytics, redash, Apache superset, metabase, Pentaho, Jaspersoft, visme, infogram, flourish, raw graphs, chartbuilder, open refine, gephi, cystoscope, among other visualization tools.

The instructions can cause the metrics to display on a graphical user interface of the administrative device 104. In some instances, the metrics can indicate anomalies with each computing device 104. The graphical user interface can include one or more graphical user interface elements for a user (e.g., manager, administrator, supervisor) to interact with the metrics. For example, the instructions can cause the metrics to display as a line graph, scatter plot, bar graph, among other types of visual representations. The graphical user interface elements can include a button, key press, a slider, a text input, among other graphical user interface elements. In some instances, the metrics can include recommendations to address the anomaly. Based on the recommendations, the user can select a graphical user interface element to transmit a request to the template identifier 114 to generate a message for at least one computing device 104 in the plurality of computing devices 104 associated with the increase in total elapsed time. For example, the anomaly can indicate that the users of at least one computing device 104 have not used paid time off (PTO) for the entire year, therefore the recommendation within the metric be to transmit a message encouraging a user of the computing device to use the available PTO.

In response to receiving the request to generate a message from the administrative computing device 104 or concurrent to providing the instructions to the computing device 104, the template identifier 114 can identify, determine, or otherwise select a template based on the profile 120 for the computing device, the violated criteria of the one or more parameters, the request from the administrative computing device 104, and the one or more parameters causing the increase in total elapsed time. The template can be a data structure that include static elements (e.g., branding styling, fixed text, etc.) and a plurality of placeholders (e.g., dynamic variables). The template can include a collection of words, phrases, or characters, among others that include a plurality of placeholders for changes, adjustments, and transformations of the message. The placeholders can allow for the computer model 118 to create personalized messages for each computing device 104 using the corresponding profile 120. The template identifier 114 can select the template according to the request. For example, the request can correspond to vacation time, career growth, job requirements, time in role, among other requests, therefore the template identifier 114 can select a template that includes placeholders for one or more of vacation time, career growth, job requirements, and time in role. The request can cause the data processing system 102 to resolve the one or more parameters indicating the anomaly. The anomaly can correspond to an indicator based on at least one elapsed time, the indicator corresponding to one or more of an address discrepancy, missing verification information, missing registration data, time anomalies, or payroll modifications, among other anomalies.

The template identifier 114 can determine whether a template library within the database includes at least one template that includes a placeholder field that maps to the anomaly by querying the template library to resolve the one or more parameters. If a template does not include a field according to a request or the one or more parameters, the template identifier 114 can add a template to a template library using data associated with the profile 120 and the data within the applications executing on the computing device 104. The template library can include a plurality of templates, each of which standardize the presentation of the messages and notifications. For example, the template library can include compliance templates, operational templates, and engagement templates that include instructions, placeholders for anomalies, and fixed text. The template library can be a data store or centralized repository within the database 106 that allows for the template identifier 114 to query by the type of template or classification of the anomaly.

If the template library includes one or more templates that can resolve the one or more parameters, the template identifier 114 can assign a score to each of the one or more templates. The score can indicate the number of placeholder fields that correspond to the anomaly. From here, the template identifier can identify or determine that the score for the template satisfies a threshold. The threshold can indicate that the template includes placeholders which match each of the anomalies and correspond to the at least one computing device based on the data extracted from the executed application. If none of the templates satisfy the threshold, the template identifier can generate the template using information within the request, by feeding the computer model 118 the request, or via a modification of one or more templates with the smallest deviation from the threshold. In modifying, the template identifier 114 can include or remove one or more placeholder fields based on the profile 120 or data extracted from the application and the anomaly.

In selecting the template, the template identifier 114 can use the instruction indicating the one or more parameters causing the increase in the total elapsed time. Based on the one or more parameters causing the increase in elapsed time, the template identifier 114 can assign or establish a classification. The classification can indicate a type (e.g., address review, payroll variance, time in role, wage compliance) for the template. The placeholder fields can correspond to the type for the template. Each template within the template library can include the respective type. From here, the template identifier 114 can compare the classification to the placeholder fields within the template. In response to a match between the classification and the placeholder field, the template identifier 114 can populate the placeholder field of the template with the classification by executing a computing operation. The computing operation can map the type for the template to the data within the profile 120 associated with the at least one computing device executing the application.

The template identifier 114 can store, house, or otherwise maintain an association between the selected, generated, or modified template and the computing devices 104. The association can be a link, a map, or a connection between the template and the computing devices 104. To store the association, template identifier 114 can generate one or more data structures. The one or more data structures can include an array, a linked list, a stack, a tree, a hash table, among others. Based on the association, the template identifier 114 can provide the computer model 118 with the template to dynamically resolve the one or more parameters causing the anomaly without input from the computing device.

The prompt generator 116 can generate, determine, or otherwise identify a prompt based on the template. Using the template, the prompt generator 116 can extract information from the profile 120 of the respective computing device 104. The prompt generator 116 can use the information to adjust the template by creating a prompt personalized for the user of the computing device 104. The information can include department of the computing device 104, age of the user of the computing device 104, the hobbies of the user, location of the computing device 104, entity of the computing device 104, among other information associated with the computing device 104. The prompt generator 116 can change the words, phrases, or characters of the template, adjust the locations of the placeholders, and add/remove placeholders within the template. In this manner, the prompt generator 116 can guide and train the computer model to personalize the message for the respective computing device 104.

The computer model 118 can ingest the prompt to generate, output, or otherwise create a message for display at the computing device 104 associated with the computing device 104. The computer model 118 can be configured to Prior to generating the prompt, the prompt generator 116 can train, establish, or otherwise update the computer model 118 using the training dataset 122. The training dataset 122 can include a plurality of examples for various computing device 104. Each example can include a sample prompt, a sample request, and a target output message for the respective computing device 104. In operation, the computer model 118 can ingest the sample prompt and the computing devices 104 indicated in the sample request. Once ingested, the computer model 118 can fill in the placeholders of the sample prompt and further adjust the words within the prompt to personalize the message for each computing device 104 within the sample request. Upon generation of the message, the prompt generator 116 can compare the output message for the computing device 104 with the target output message for the computing device 104. Using the comparison, the prompt generator 116 can generate a loss metric to update one or more weights of the computer model 118. In this manner, the computer model 118 can be updated to further personalize messages for each computing device 104 associated with an entity. From here, the instruction generator 112 can generate an instruction to display the message on the computing device 104 as indicated within the request.

The instruction generator 112 can generate instructions to transmit the message to various platforms associated with an entity, such as mobile devices, applications, electronic mail, a Chabot agent, computing devices, among other platforms. For example, the instruction generator 112 can transmit the message to a chatbot/artificial intelligence agent for display during a conversation on the computing device 104 or the administrative computing device 104. In another example, the instruction generator 112 can generate instructions to transmit the message to a payroll application executing on the computing device 104. In this manner, the system 100 can provide the message to any computing device 104 within the entity. By personalizing the message, the systems and methods described herein can reduce the one or more parameters causing the increase in the total elapsed time. In some instances, the instruction generator 112 can transmit a subsequent instruction that includes one or more recommendations to reduce or eliminate the one or more parameters and the total elapsed time. The recommendations can include scheduling and workflow adjustments; data and compliance remediation; resource allocation; behavioral and engagement suggestions; policy or threshold changes; automation opportunities; and escalation or multi-level communication.

In response to receiving an input to the message from at least one computing device 104, the prompt generator 116 can verify that the input addresses the modification or the anomaly. In verification, the prompt generator 116 can identify that the input includes one or more values that satisfy the criteria for the one or more parameters. For example, the input can include values that correspond to a missing SSN. In another example, the input can include an indication that the computing device is utilizing PTO. In another example, the input can include one or more values that match an expected value within the placeholder fields of the template. In response to a successful verification of the input, the prompt generator 116 can prevent the computer model 118 from generating a subsequent instruction at the time interval. In response to an unsuccessful verification, the instruction generator 112 can use the computer model 118 to generate and transmit a subsequent instruction at a later time interval.

In some non-limiting examples, nudges can be used to guide users of at least one computing device 104 and manages to go through the process with less frictions and efforts. For example, annual enrollment and life event changes are common processes. Performance evaluations and coaching are continuous processes. Manager and employee coaching can occur within the workflow and is contextual. An effortless way to build team culture and best practice consistency. Whether it is for a new hire, or a new team or project member, connecting with relevant members is the most essential steps. Managers could build project, team, and organizations to get-started guidance as nudges to make newcomers feel at-ease and at-home. Capture and promote best practices using nudges. A platform to develop, customize and socialize effective nudging practices for clients' developers. Made-ready APIs, events and data connections, scalable workflow execution engine that allow development of high-performing nudging flow effortlessly. Users of at least one computing device 104 use nudges to make knowledge exchanges, to connect with other users.

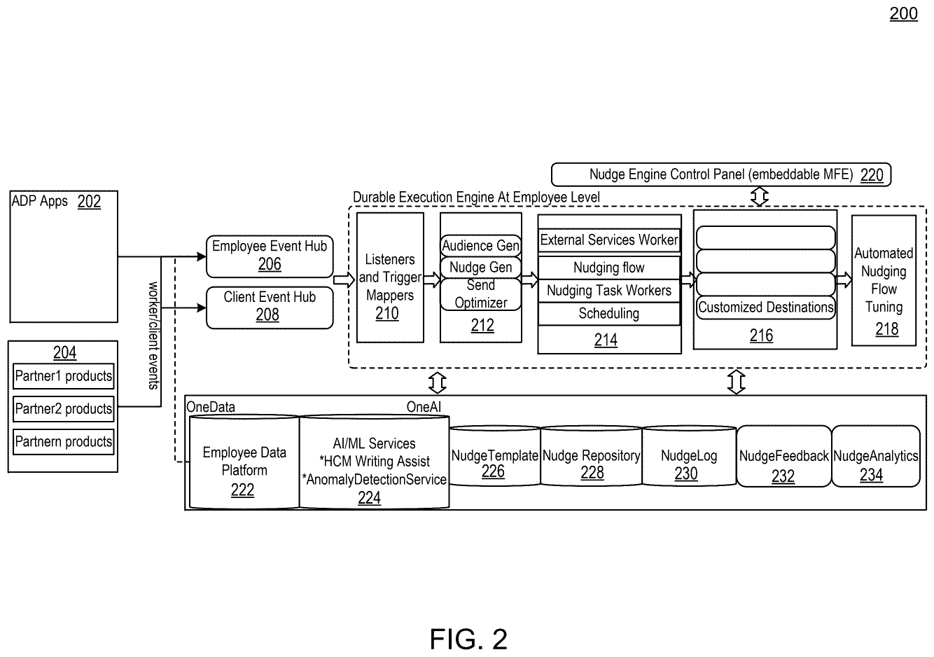

FIG. 2 is an illustrative example of a system level architecture 200 of the framework. The system level architecture 200 can be an example implementation of the systems and methods described herein. The system level architecture 200 can include application 202, partner products 204, employee event hub 206, client event hub 208, listeners and trigger mappers 210, block 212, block 214, customized destinations 216, automated nudging flow tuning and nudge analytics 218, nudge engine control panel 220, employee data platform 222, AI services 224, nudge template 226, nudge repository 228, nudge log 230, nudge feedback 232, nudge analytics 234. The nudge setup configurations allow users to instantiate existing nudge templates, configure triggers, audience, content, channels and schedules. The nudge template setup customization can allow users and admins to set up and configure company nudge templates. The nudge dashboard can display operational analytics and controls the user is entitled to.

The data components can include a nudge template repository that stores system level nudge templates across domains. The client and employee nudge instance repository stores client-level nudge templates. The client and employee nudge instance repository stores operational details for active nudges. The system level architecture 200 can further include RAG pipelines retrieving and compiling workflow-aware content, APIs invoking persona and context aware analytics, and context-aware actions. The workflow components can include HCM Domain Specific Language(DSL) that are abstract triggers, HCM workflow components as building blocks for nudge templates customization. The workflow engine core leverages next-gen workflow engine to manage infrastructure level operations and achieve out-of-box scalability, resilience and security.

The applications 202 can be configured to execute on a plurality of computing devices 104 and can allow users to access functions of the nudge engine. The application 202 can provide requests or event data to upstream locations such as the employee event hub 206. The application 202 can use authentication methods such as multi-factor authentication, single sign-on, or password verification, and by establishing secure connections to transmit data to the event hubs.

The partner products 204 can represent external applications integrated with the nudge engine to exchange data and access the systems and methods described herein. The partner products 204 can provide event information from outside systems and can receive data generated by the nudge engine. The partner products 204 can use secure API endpoints, formatting data to match internal schemas, and publishing event messages to the data processing system 102.

The employee event hub 206 can process events relating to individual users of at least one computing device 104. The employee event hub 206 can accept event data from the application 202 and can forward the data to the data processing system 102 for trigger evaluation. The employee event hub 206 can perform validation, normalization, and publish events to message queues for downstream use.

The client event hub 208 can process events received from client-specific systems. The client event hub 208 can handle event data from integrations or third-party tools and can forward the events for mapping and trigger evaluation. The client event hub 208 can execute API calls, authenticate source systems, and convert event formats to match internal data structures.

The listeners and trigger mappers 210 can monitor event streams from the employee event hub 206 and the client event hub 208 and can assign triggers to the events. The listeners and trigger mappers 210 can read event data, reference mapping rules, and call services when trigger conditions are matched or occur

The block 212 can include an audience gen, nudge gen, send optimizer to carry out targeting, content creation, and delivery functions. The audience gen 212 can select recipients by evaluating event and profile data. The nudge gen 212 can produce messages by retrieving templates from the nudge template 226 and inserting parameter values. The send optimizer 212 can determine delivery timing and channel by referencing stored configuration and performance data.

The block 214 can manage communication, execution, and timing between the data processing system 102 and the computing devices 104. The external services worker 214 can transmit data to external endpoints (e.g., external computing devices 104). The nudging flow 214 can coordinate ordered steps for processing from event intake to output generation. The nudging task workers 214 can perform defined operations such as querying data or populating templates. The scheduling 214 can set execution times by referencing schedule records and applying time offsets.

The customized destinations 216 can direct output data to particular target systems or groups. The customized destinations 216 can read destination configuration and select transport methods accordingly. The automated nudging flow tuning 218 and nudge analytics 218 can process performance data and adjust configuration for subsequent operations. The automated nudging flow tuning 218 can modify processing definitions based on analysis, and the nudge analytics 218 can compute metrics from recorded system data.

The nudge engine control panel 220 can provide an interface for system configuration and observation. The nudge engine control panel 220 can display operational data and allow changes to stored settings by communicating with backend services associated with the data processing system 102.

The employee data platform 222 within the database 106 can store records related to users of the system. The records can include the data within profile 120 of the computing device 104. The employee data platform 222 can respond to queries for information such as identifiers, roles, or attributes and can write updates based on external input. The AI services 224 within the database 106 can run computing models for classification or prediction. The AI services 224 can process input features from stored datasets and return inferred results to requesting sections of the system.

The nudge template 226 within the database 106 can hold message formats. The nudge template 226 can store definitions with placeholders and can allow selection to generate output with inserted values. The nudge repository 228 within the database 106 can maintain records of messages generated by the system. The nudge repository 228 can support retrieval by identifiers and can store associated data fields for reference. The nudge log 230 within the database 106 can record events relating to message generation and transmission. The nudge log 230 can append entries with time stamps and identifiers to support later processing.

The nudge feedback 232 within the database 106 can store information returned from target systems or devices (e.g., computing devices 104) in response to transmission of the instructions. The nudge feedback 232 can capture data values and associate them with originating message identifiers. The nudge analytics 234 within the database 106 can compute data summaries from the nudge log 230 and the nudge feedback 232. The nudge analytics 234 can perform data queries and provide results to sections such as the automated nudging flow tuning 218. The nudge analytics 234 can include visualizations, reports, graphs, among others.

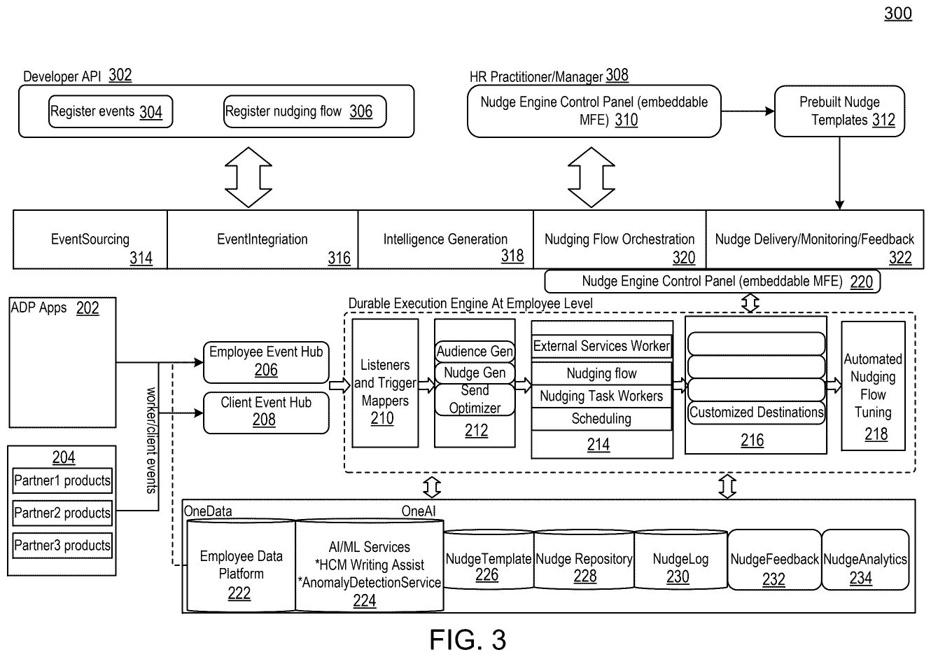

FIG. 3 is an illustrative example of the system level architecture 300 of the framework with templates for message generation. In the architecture 300, the applications on the computing device 104 can transmit events associated with a user to an employee hub. The computer model 118 can use one or more listeners and event mappers upon detection of the events. From here, the computer model 118 can generate a schedule, a group of users, and a flow to generate the message for the computing devices 104. Concurrently, the computer model 118 can extract data from the database 106 to complete each task described in the architecture 300.

The architecture 300 can be arranged to permit external systems, practitioners, and managers to interact with the nudge engine in a controlled and configurable manner. The architecture shown in FIG. 3 can include developer API 302, register events 304, register nudging flow 306, human resources (HR) manager 308, nudge engine control panel 310, prebuilt nudge templates 312, event sourcing 314, event integration 316, intelligence generation 318, nudging flow orchestration 320, nudge delivery 322.

The developer API 302 can be configured to enable programmatic interactions with the nudge engine (e.g., computer model 118). The developer API 302 can send and receive data in formats accepted by the system and can allow external programs to invoke operations. The developer API 302 can expose endpoints that process input requests and return output data.

The register events 304 can be configured to add new event definitions into the nudge engine. The register events 304 can accept data that specifies the type of event, associated parameters, and handling instructions. The register events 304 can store the provided definitions in event registries accessible to other sections of the system.

The register nudging flow 306 can be configured to add process flows that define steps to execute after specific events occur. The register nudging flow 306 can accept flow descriptions, trigger associations, and delivery configurations. The register nudging flow 306 can write the flow data into a registry for retrieval by orchestration services.

The HR manager 308 can be configured to interact with the nudge engine through user-facing interfaces. The HR manager 308 can request changes, view event information, or trigger flows as permitted. The HR manager 308 can send commands through authenticated connections to the control panel 310.

The nudge engine control panel 310 can be configured for display to the HR manager 308. The nudge engine control panel 310 can present interface elements to view, configure, or operate flows. The nudge engine control panel 310 can read configuration data from registries and send updates through secure API calls.

The prebuilt nudge templates 312 can be configured to store prepared template definitions for messages. The prebuilt nudge templates 312 can allow immediate use without additional design work. The prebuilt nudge templates 312 can retain static content and placeholder fields to be populated during message creation.

The event sourcing 314 can be configured to collect events from defined inputs. The event sourcing 314 can ensure that data from these events is made available to downstream systems. The event sourcing 314 can subscribe to input feeds and produce event objects in a standard format. The event integration 316 can be configured to merge events from multiple origins. The event integration 316 can relate data fields and combine information as required. The event integration 316 can apply mapping logic to produce unified event records.

The intelligence generation 318 can be configured to create analytical outputs based on event data. The intelligence generation 318 can apply processing logic to translate or modify the received event data into a format acceptable by the data processing system 102. The intelligence generation 318 can run calculations or model inference on stored datasets.

The nudging flow orchestration 320 can be configured to control, manage, or otherwise maintain the delivery of the instruction. The nudging flow orchestration 320 can determine and order of operations and manage dependencies to trigger the nudge delivery 322. The nudge delivery 322 can be configured to transmit messages produced by the nudge engine and record information related to their handling. The nudge delivery 322 can track results such as delivery confirmation or returned data. The nudge delivery 322 can send outputs (e.g., instructions) to destination systems (e.g., computing device 104) and receive status signals indicating an acknowledgement of the instruction.

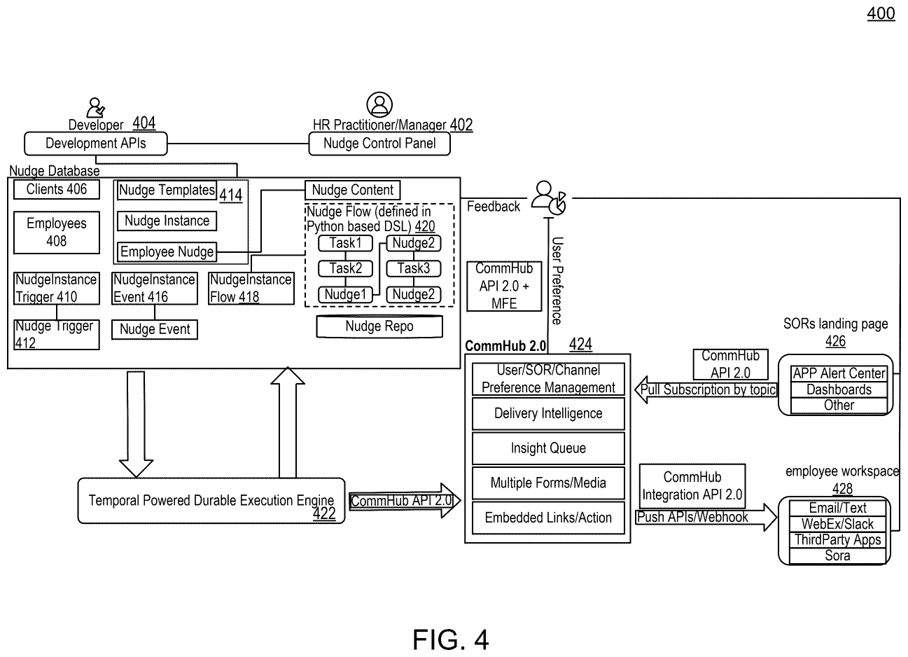

FIG. 4 is an illustrative example of a service level view 400 of the framework. Security can include CMK KMS Key rotation for data associated with one or more of RDS, S3 bucket for terraform state management, DynamoDB table for terraform lock management, Lamda CloudWatch logs, IAM Roles with restrictive privileges, and AWS Secret manager for RDS Secrets. The view 400 can include HR manager 402, developer 404, clients 406, employee 408 (e.g., users of the at least one computing device 104), nudge instance trigger 410, nudge trigger 412, block 414, nudge instance event 416, nudge instance flow 418, nudge flow 420, temporal powered durable execution engine 422, communications hub 424, landing page 426, employee workspace 428.

The HR manager 402 can interact with the nudge engine through the nudge control panel. The HR manager 402 can view information regarding nudges, configure parameters for triggers and flows, and initiate actions. The HR manager 402 can transmit configuration changes or operational commands by authenticated requests to the control panel and related APIs. The HR manager 402 can be the same as the HR manager 308.

The developer 404 can interface with the nudge engine through one or more development APIs. The developer 404 can register new events, define nudging flows, and update system configurations using these APIs. The developer 404 can exchange data with the nudge engine by calling exposed endpoints and providing event or flow definitions in accepted formats. The developer can use the developer APIs' 302 described in FIG. 3.

The clients 406 can operate from computing devices 104 external to an entity to interact with the nudge engine. The clients 406 can supply event data, request nudges, or respond to messages generated by the system. The clients 406 can communicate by sending data over secure connections to the nudge engine APIs or event hubs.

The users of at least one computing device 104 can operate from computing devices 104 internal to an entity to interact with the nudge engine. The users of at least one computing device 104 can receive nudges, provide feedback, and trigger events during regular application use. The users of at least one computing device 104 can transmit interaction data and event information to the nudge engine using secure application sessions.

The nudge instance trigger 410 can represent a stored condition that associates a specific event with a triggerable nudge instance. The nudge instance trigger 410 can be referenced when incoming event data matches defined criteria. The nudge instance trigger 410 can initiate retrieval of nudge content and flow execution.

The nudge trigger 412 can represent a general condition definition for initiating a nudge. The nudge trigger 412 can store event relationships and associated actions to be taken when those events are detected. The nudge trigger 412 can be evaluated against event data received by the system to determine initiation of a nudge.

The block 414 can include nudge templates, nudge instances, and employee nudge that store reusable message formats, active nudge records, and nudge definitions associated with employee delivery. The nudge templates 414 can define structural layouts and placeholders. The nudge instances 414 can maintain runtime data for active nudges. The employee nudge 414 can be configured with parameters specific to internal employee delivery scenarios.

The nudge instance event 416 can store event records tied directly to a nudge instance. The nudge instance event 416 can provide event context for flow execution and message generation. The nudge instance event 416 can be read during processing to retrieve necessary parameter values for a nudge.

The nudge instance flow 418 can define ordered steps for processing a specific nudge instance from trigger to delivery. The nudge instance flow 418 can contain references to tasks, templates, and delivery channels. The nudge instance flow 418 can be executed by orchestration logic to perform each specified step.

The nudge flow 420 can contain a defined set of tasks to be completed in relation to a detected event or condition. The nudge flow 420 can specify actions required before a nudge is sent, and if tasks are not completed, the associated nudge message is transmitted. The nudge flow 420 can be structured using scripts or definitions in a supported language such as Python DSL for orchestration by the system.

The temporal powered durable execution engine 422 can coordinate execution of flows and tasks with support for persistence and recovery. The temporal powered durable execution engine 422 can track execution state of nudges and related actions and resume processing after interruptions without data loss. The temporal powered durable execution engine 422 can call tasks and deliver outputs as configured by flow definitions.

The communications hub 424 can transmit nudge messages across available channels and manage delivery preferences. The communications hub 424 can include systems for preference management, delivery intelligence functions, insight queues, multiple content forms and media, and embedded links or actions. The communications hub 424 can route messages using the communication hub API and integrate with external communication endpoints.

The landing page 426 can be an endpoint interface displaying system outputs such as alerts, dashboards, and other views. The landing page 426 can receive data from the communications hub 424 and present the data to users via secure application access. The landing page 426 can handle user navigation to detailed views or linked resources.

The employee workspace 428 can deliver nudges and related communications to users of at least one computing device 104 through electronic channels. The employee workspace 428 can provide email, text, Webex/Slack integration, third-party application connections, and sora platform access. The employee workspace 428 can receive payloads from the communications hub 424 and present them through the configured channels.

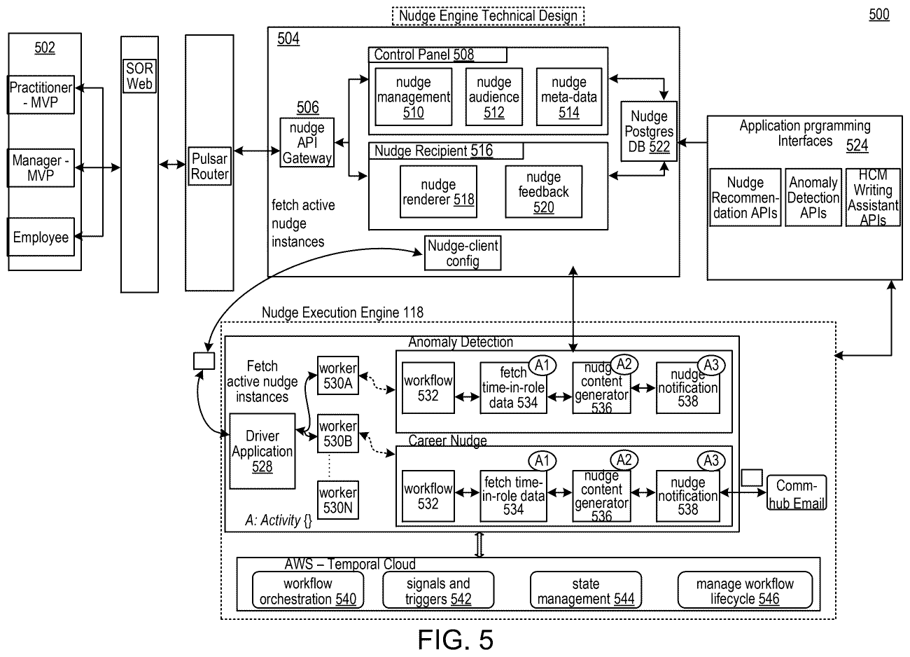

FIG. 5 is an illustrative example of a component level view 500 of the computer model 118 within the framework. The view 500 can include can include a user 502, SOR web 504, nudge API gateway 506, control panel 508, nudge management 510, nudge audience 512, nudge meta-data 514, nudge recipient 516, nudge renderer 518, nudge feedback 520, nudge Postgres DB 522, application programming interfaces 524, driver application 528, worker 530a, worker 530b, worker 530n, workflow 532, fetch time-in-role data 534, nudge content generator 536, nudge notification 538, workflow orchestration 540, signals and triggers 542, state management 544, manage workflow lifecycle 546.

The user 502 can include user roles defined within the nudge engine architecture. The user 502 can be a practice, manager, or employee. The practitioner 502 can be used for administrative configuration of nudges, including managing triggers and flows. The manager 502 can be used for team-level review and interaction with nudges. The employee 502 can be used for receiving and responding to nudges applicable to their assigned role. The practitioner 502, manager 502, and employee 502 can perform actions by accessing authenticated client applications, establishing authorized sessions, and transmitting operational data to downstream services in the nudge engine.

The SOR web 504 can be a web-based access point positioned between user roles 502 and nudge engine backend services. The SOR web 504 can be used to render interface views, accept data entry, and manage session persistence for users. The SOR web 504 can transmit collected actions and configuration updates directly to backend APIs using established network protocols.

The nudge API gateway 506 can be an API gateway layer configured to handle inbound and outbound API traffic for nudge operations. The nudge API gateway 506 can process requests to retrieve active nudge instances and direct them into the execution pipeline. The nudge API gateway 506 can perform schema validation on incoming payloads, apply routing rules to determine destination services, and convert data formats as needed for compatibility.

The control panel 508 can be a management interface for internal administration of nudge data and flow settings. The control panel 508 can include nudge management 510 for defining nudge instances and templates, nudge audience 512 for setting targeting rules, and nudge meta-data 514 for storing descriptive parameters and operational conditions. The control panel 508 can execute database operations to retrieve existing settings and commit modifications to the nudge Postgres DB 522.

The nudge recipient 516 can be the processing section that manages the generation and receipt of message payloads. The nudge recipient 516 can incorporate the nudge renderer 518, which constructs messages from templates with inserted live data, and the nudge feedback 520, which records responses or status information after delivery. The nudge recipient 516 can exchange data with storage services for template retrieval and feedback record updates.

The nudge Postgres DB 522 can be a relational database utilized for persistent storage of nudge configurations, templates, targeting data, feedback records, and operational logs. The nudge Postgres DB 522 can respond to SQL queries from application layers, returning required records to the control panel 508, nudge recipient 516, and other processing modules.

The application programming interfaces 524 can be collections of service endpoints enabling integration with external applications and systems. The nudge recommendation APIs within the application programming interfaces 524 can return recommended nudge content based on input parameters. The anomaly detection APIs within the application programming interfaces 524 can evaluate supplied datasets against anomaly rules. The HCM writing assistant APIs within the application programming interfaces 524 can generate message text suitable for human capital management scenarios. The application programming interfaces 524 can process structured requests, perform required computations or lookups, and generate defined responses.

The driver application 528 can be the execution control module responsible for retrieving active nudge instances and dispatching tasks to worker 530A, worker 530B, and worker 530N. The driver application 528 can assign task segments to each worker and track execution status until completion. The driver application 528 can coordinate task execution by reading workflow definitions and invoking appropriate processing services.

The worker 530A, worker 530B, and worker 530N can be parallel task execution units invoked by the driver application 528. The worker 530A, worker 530B, and worker 530N can carry out assigned operations such as collecting data, transforming fields, or sending delivery calls. The worker 530A, worker 530B, and worker 530N can interact directly with service APIs or data repositories, writing status and output data upon task completion.

The workflow 532 can be an ordered process instruction set used for executing a nudge. The workflow 532 can direct tasks from input data acquisition through content creation to notification issuance. The workflow 532 can execute calls to specified service modules in sequence in accordance with flow logic.

The fetch time-in-role data 534 can be a retrieval operation that collects data on user tenure in a specific organizational role. The fetch time-in-role data 534 can provide numerical values used in workflow 532 decision nodes to determine triggering conditions for nudges. The fetch time-in-role data 534 can source records from designated personnel datasets and compute role duration values.

The nudge content generator 536 can be the message assembly unit for nudge content production. The nudge content generator 536 can merge static template structures with variable parameters retrieved during workflow execution. The nudge content generator 536 can output completed payloads to appropriate notification handlers following formatting standards for the selected delivery channel.

The nudge notification 538 can be the delivery handler for final nudge outputs. The nudge notification 538 can transmit payloads to target endpoints via channel-specific APIs. The nudge notification 538 can record return codes or status information to confirm the transmission result.

The workflow orchestration 540 can be the supervisory system for managing workflow 532 execution across multiple services. The workflow orchestration 540 can launch activities, handle inter-task dependencies, and trigger subsequent processes once prior steps are complete. The workflow orchestration 540 can maintain execution order and timing through orchestration logic.

The signals and triggers 542 can be the event evaluators that determine when workflows should initiate. The signals and triggers 542 can compare live event data to stored trigger definitions and start matching workflows. The signals and triggers 542 can subscribe to event streams and call workflow logic upon condition match.

The state management 544 can be the service maintaining workflow execution state. The state management 544 can store checkpoints to allow workflows to resume from the correct step after suspension or interruption. The state management 544 can update state records during each task execution to ensure continuity.

The manage workflow lifecycle 546 can be the control system overseeing workflows from initiation to termination. The manage workflow lifecycle 546 can perform actions such as starting, pausing, resuming, or ending workflows. The manage workflow lifecycle 546 can call orchestration commands and update lifecycle records in storage.

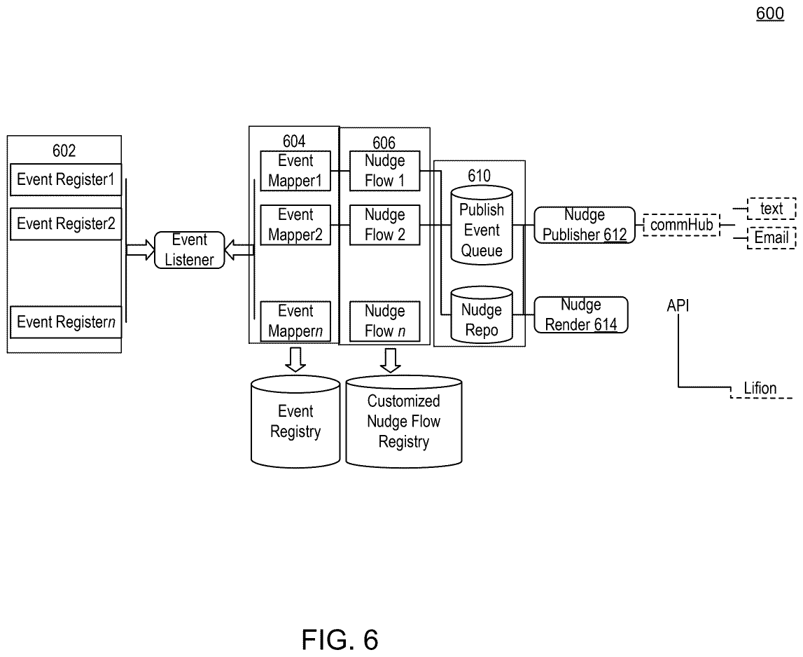

FIG. 6 is an illustrative example of a platform general flow diagram 600 of a process for the framework. In the flow diagram 600, at step 602 an event listener can detect a plurality of events at the computing devices 104. At step 604, an event mapper can map the events to the database 106. The database 106 can include an event registry to store and maintain events. At step 606, the data processing system 102 can execute a nudge flow corresponding to a respective computing device 104. At step 610, the data processing system 102 can establish an event queue that stores each of the messages in an order to generate the messages. The computer model 118 can use the events to generate the messages for the computing devices 104 in accordance with the queue. At step 614, the data processing system 102 can render the nudge within the message. At step 612, the data processing system can transmit the messages through text, email, and application, among other forms of communication.

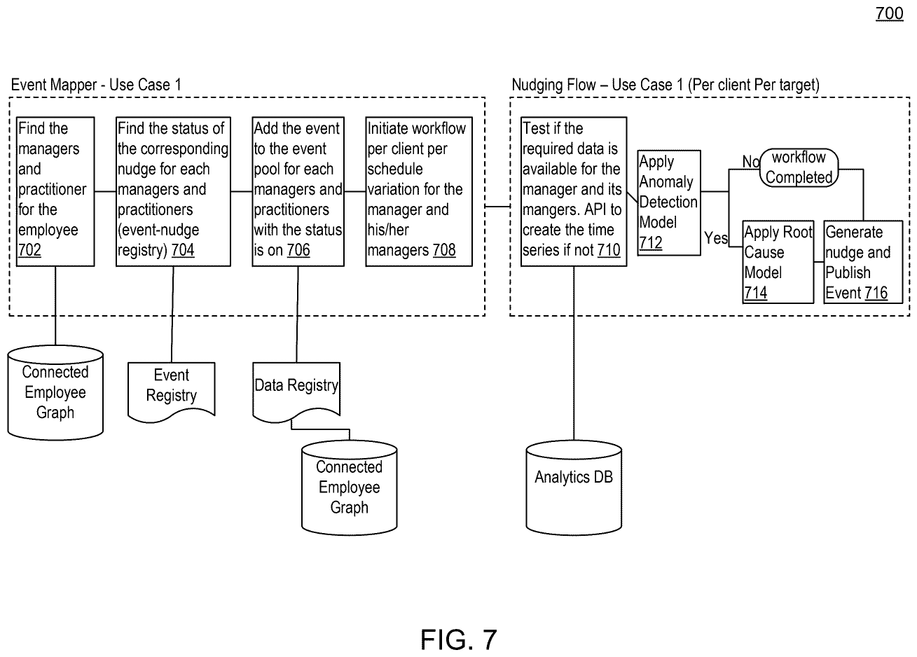

FIG. 7 is an illustrative example of a flow diagram 700 of uses cases for the framework. At step 702, the data processing system can query the database to identify an administrative computing device 104 for the computing device 104. The database 106 can include an employee's personal and employment information of various SOR's that are collected in SGDP (e.g., database 106) and available to all downstream applications. At step 704, the data processing system 102 can identify whether there is a pending message that has not be viewed by the user within the event registry. The event registry can be similar to the event registry in the flow diagram 600. If the event registry does not include a pending message, the data processing system 102 can add a request in a queue to generate an instruction (e.g., nudge, event message) for provision to the computing device 104, at step 706. The data processing system can extract data or information from the employee graph within the database 106. At step 708, the data processing system can initiate a workflow per client per schedule variation for the manager and managers. For example, using the data extracted from the employee graph, the data processing system 102 can trigger its various components according to a schedule of the computing device 104. At step 710, the data processing system can test if the required data is available for the manager and its managers, and if not, can use an API to create the time series. For example, the data processing system 102 can determine whether the database 106 satisfies a threshold for data associated with the user by generating a score based on the profile 120 of the computing device. If the score does not satisfy the threshold, the data processing system can execute one or more APIs to generate a schedule to complete the profile 120. Otherwise, the data processing system 102 can execute the computer model 118. At step 712, the data processing system can apply an anomaly detection model to determine whether the data includes an anomaly. The data processing system can determine whether the time series data created using the API has an anomaly. The computer model 118 can be an intelligent informative system for users, which analyzes the employee's data in the SGDP and applies ML based decision logic to generate nudge messages for the given use case. At step 714, the data processing system 102 can apply the various components of the computer model 118 and generate the instruction for the computing device 104 at step 716. These messages can be extracted and published to a mobile platform through SNS topics, which can provide a notification to the users upon logging to the mobile application.

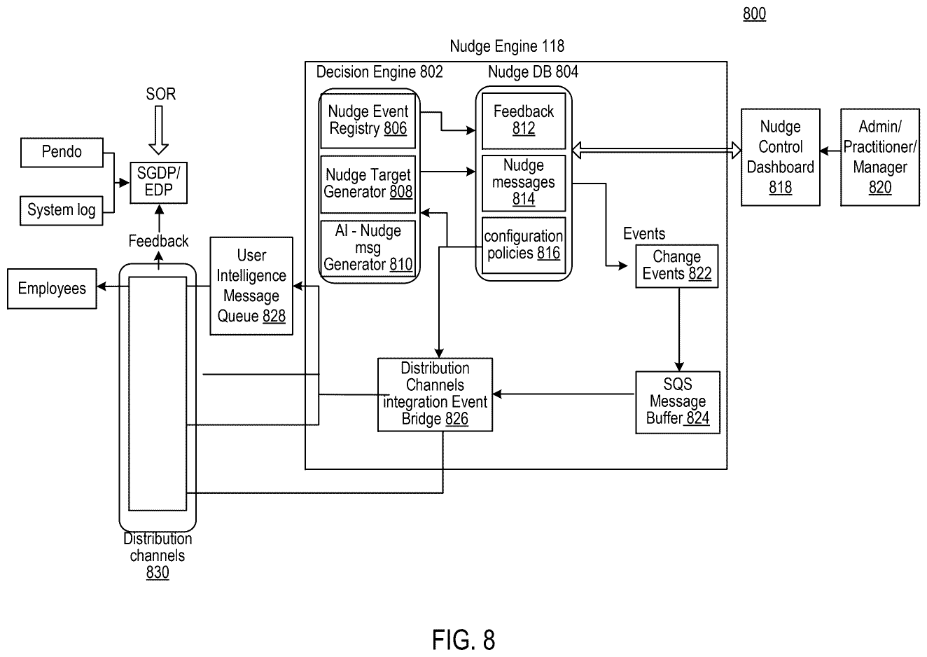

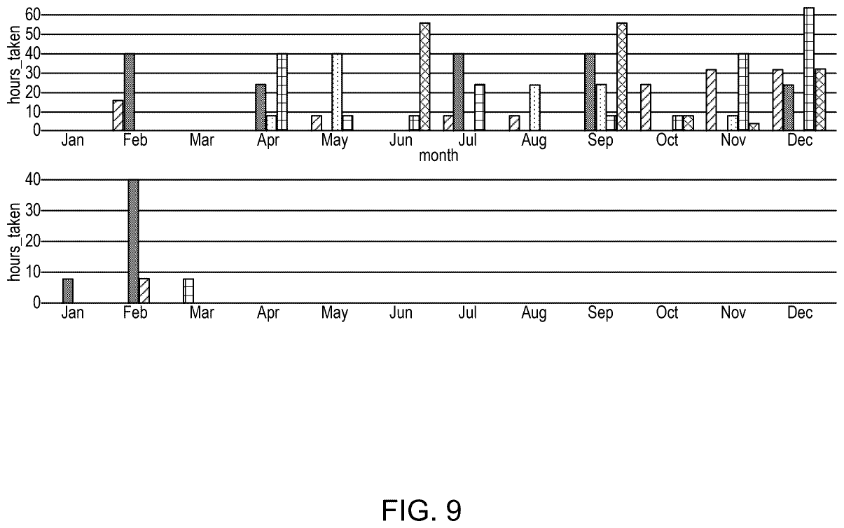

FIG. 8 is an illustrative example 800 of the computer model 118. The structure of the message generated by the computer model 118 can be in accordance with an html structure. Using the templates, the computer model can generate the message for the computing device 104 of the user. The templates can state, “It has been x days since your last vacation. Take care of yourself. Plan some time off <PTO request URL>,” “You have accrued XX hours in float and vacation time. “As you grow older, you learn a few things. One of them is to actually take the time you have allotted for vacation,” “‘You have accrued XX hours in float and vacation time. Take care of yourself. Enjoy perks—<insert perks>—Up to $700 Off Vacation Packages, Flights and More. <insert perk link>”, “XXX of your accumulated float/vacation hours will expire by end of year, equivalent to $$$. Plan some time off <PTO request URL>”, among other templates. FIG. 9 is an illustrative example of metrics 900 displayed to the administrative computing device 104. The metrics can correspond to vacation time for users of the computing devices 104 within a department, sector, or entity.

The example 800 can include decision engine 802, nudge DB 804, nudge event registry 806, nudge target generator 808, ai-nudge message generator 810, feedback 812, nudge messages 814, configuration policies 816, nudge control dashboard 818, administrator 820, change events 822, SQS message buffer 824, distribution channels integration event bridge 826, user intelligence message queue 828, distribution channels 830.

The decision engine 802 can be a processing system within the computer model 118. The decision engine 802 can evaluate event data, determine target recipients, and create nudge messages. The decision engine 802 can read event definitions from the nudge event registry 806, run targeting logic from the nudge target generator 808, and call the AI-nudge message generator 810 to produce messages.

The nudge DB 804 can be a storage system for nudge operations. The nudge DB 804 can store feedback 812, nudge messages 814, and configuration policies 816. The nudge DB 804 can handle data transactions with the decision engine 802, nudge control dashboard 818, and distribution channels integration event bridge 826.

The nudge event registry 806 can be a data store for event definitions. The nudge event registry 806 can provide event criteria to the decision engine 802 for matching triggers. The nudge event registry 806 can accept new event entries, store them in the nudge DB 804, and return results for event lookups.

The nudge target generator 808 can be a processing unit for identifying recipients for a nudge. The nudge target generator 808 can determine targets using stored recipient data and event parameters. The nudge target generator 808 can query the nudge DB 804 and return target lists to the AI-nudge message generator 810.

The AI nudge message generator 810 can be a message creation service. The AI nudge message generator 810 can combine templates with data from the nudge target generator 808 to produce messages. The AI nudge message generator 810 can send the completed output to the distribution channels integration event bridge 826.

The feedback 812 can be a data store for responses to delivered messages. The feedback 812 can record delivery status, acknowledgements, or interaction data. The feedback 812 can receive data from the user intelligence message queue 828 and store it in the nudge DB 804.

The nudge messages 814 can be a storage area for prepared messages. The nudge messages 814 can hold content generated by the AI nudge message generator 810 until delivery. The nudge messages 814 can be read by the distribution channels integration event bridge 826 for dispatch.

The configuration policies 816 can be a rules set for message handling. The configuration policies 816 can define conditions for nudge creation and delivery. The configuration policies 816 can be referenced by the decision engine 802 during processing.

The nudge control dashboard 818 can be a user interface for system control. The nudge control dashboard 818 can allow reading of stored data and updating of configuration policies 816. The nudge control dashboard 818 can interact with the nudge DB 804 to send and receive data.

The administrator 820 can be user roles with access to the nudge control dashboard 818. The administrator 820 can configure settings, review stored data, and trigger actions. The administrator 820 can send updates through the dashboard to the nudge DB 804.

The change events 822 can be an event monitor for detecting data modifications. The change events 822 can identify changes requiring further processing. The change events 822 can forward detected updates to the SQS message buffer 824.

The SQS message buffer 824 can be a queue for holding event messages. The SQS message buffer 824 can store messages before they are processed by the distribution channels integration event bridge 826. The SQS message buffer 824 can maintain messages until downstream systems read them.

The distribution channels integration event bridge 826 can be a connector for sending messages to distribution channels 830. The distribution channels integration event bridge 826 can read from the nudge messages 814 and format messages for delivery systems. The distribution channels integration event bridge 826 can send messages to the distribution channels 830 and pass feedback to the feedback 812.

The user intelligence message queue 828 can be a queue for collecting feedback data. The user intelligence message queue 828 can store input from distribution channels 830 and users of at least one computing device 104. The user intelligence message queue 828 can forward feedback to the feedback 812. The distribution channels 830 can be delivery endpoints for nudge messages. The distribution channels 830 can transmit prepared messages to recipients. The distribution channels 830 can provide interaction data back to the user intelligence message queue 828.

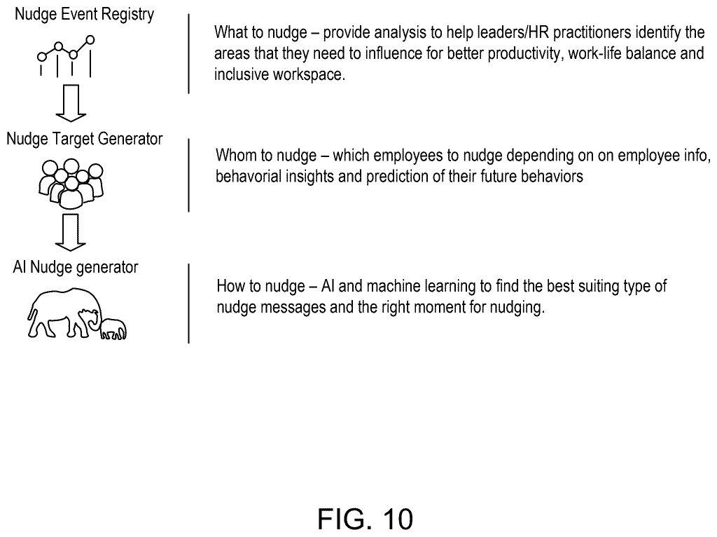

FIG. 10 is an illustrative example of a process 1000 taken by the computer model 118. To prompt HR practitioners to set up nudges, an insight generator should continuously run analyses to proactively suggest improvement opportunities. Potential analyses around vacation could be by business unit/team and the average vacation hours taken annually, by business unit/team, the percentage of vacation time expired, and the percentage of users of at least one computing device 104 who take less than X hours of vacation time per year. In this POC, the data processing system 102 can ran a manual analysis (Link) and found that significant numbers of US users of at least one computing device 104 lost more than 4 hours of vacation or float holiday at the end of year in 2022.

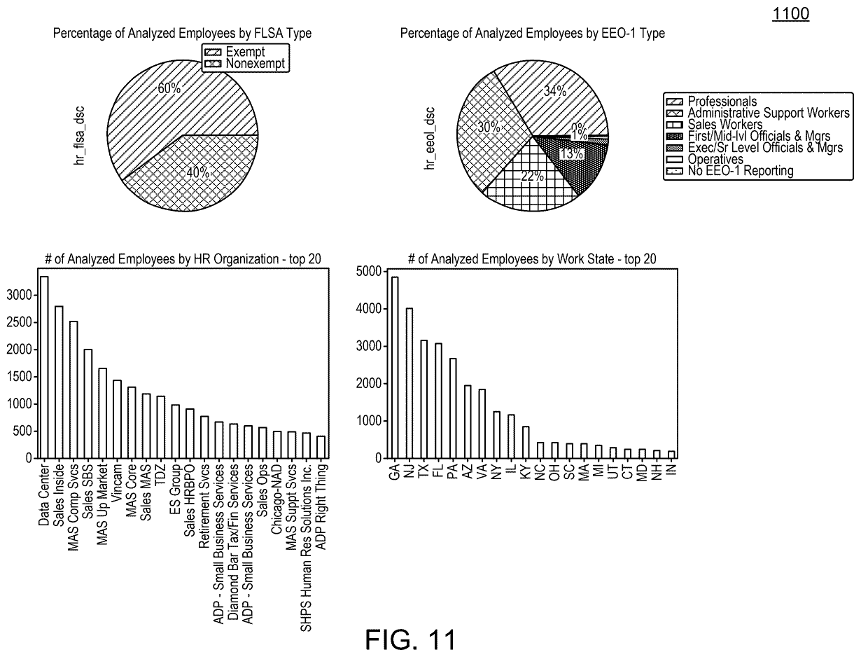

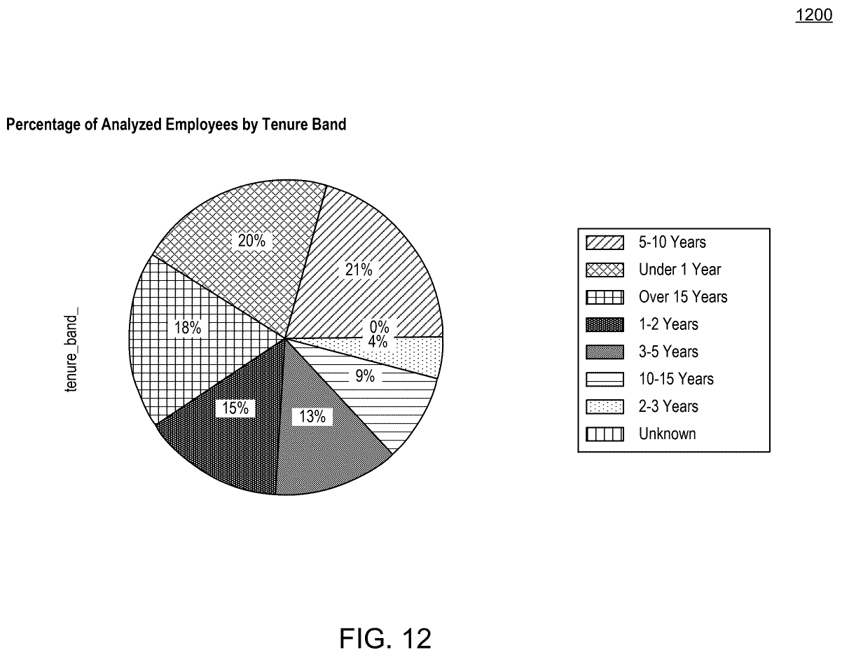

Since the data processing system 102 can are measure whether occasional nudges can reduce vacation time loss, the data processing system 102 can have framed this POC as follows, the client US users of at least one computing device 104, excluding those who don't have an accrual policy for float holiday and vacations, such as interns and consultants, and excluding those whose have high annual carryover caps Business metric to improve are the percentage of people who lost vacation time at the end of year. FIGS. 11-12 are illustrative examples of various statistics 1100 and 1200 associated with the framework showing the demographics, job and organization info of people in the POC scope.

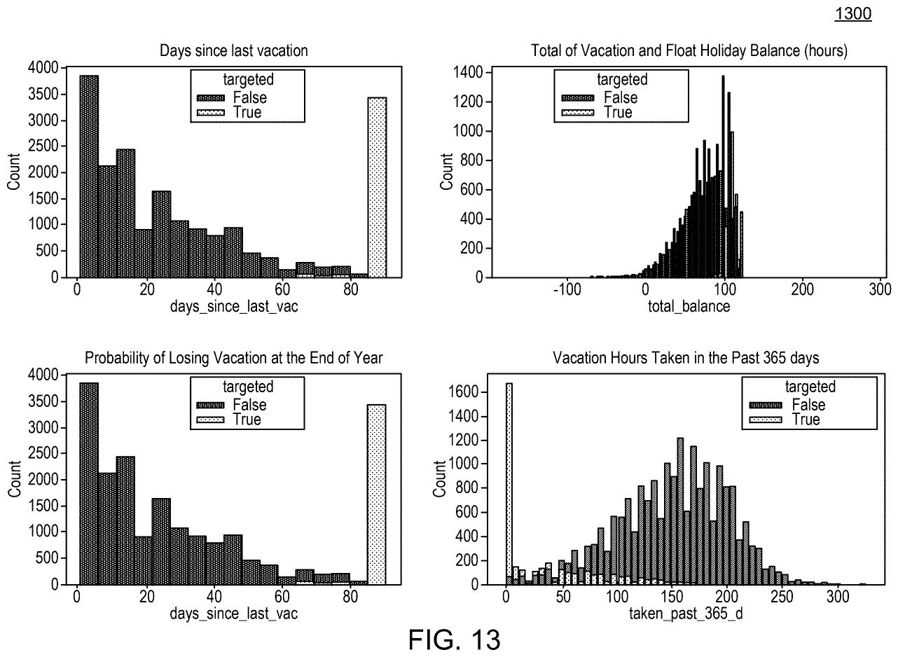

FIG. 13 is an illustrative example of various statistics 1300 associated with a use case of the framework. Computer model differentiates from other message system by using data and ML models to target the “right” employee to influence to get the biggest impact with the least amount of disturbance. A recent survey by Pew Research Center illuminates' reasons why people take less PTO than offered. The top reason is that “people feel that they didn't need to take more time off”. The 2^{nd} to 4th top reasons are related to worrying about falling behind or losing job if they take time off. The 5th reason is due to managers/supervisors discouraging people from taking time off. The survey results are consistent with intuitions. The data processing system 102 can believe that in order to encourage people to take more time off, the data processing system 102 can need to nudge two groups of people those users of at least one computing device 104 who are not taking enough vacation (in our case, who likely have expired vacation time by the end of year) and thee direct managers of people in group #1.

The data processing system 102 can build a predictive metric (vac_exp_risk) to estimate employee's risk of losing more than four hours of vacation time at the end of year. The model takes into consideration of users of at least one computing device 104′ vacation patterns in the past three years and their current vacation and float holiday balance, to estimate their end-of-year risk of vacation expiration events. The prediction accuracy gradually improves when time approaches the end of year. Accuracy ranges from seventy-nine percent at the end of March to eighty-five percent at the end of November. The data processing system 102 can use the metric as a key criteria for targeting users of at least one computing device 104 to nudge. To be considerate about user experiences, the data processing system 102 can add short-term metrics, such as ‘days since last vacation time’, ‘days till the next vacation’ in the selection criteria as well. These metrics are crucial to prevent sending out nudges when people are already in the middle of a vacation, or when they have already submitted a PTO request. Also to keep the targeting more accurate, the data processing system 102 can not send users of at least one computing device 104 with tenure <1 year vacation nudges, because of lack of historical data.

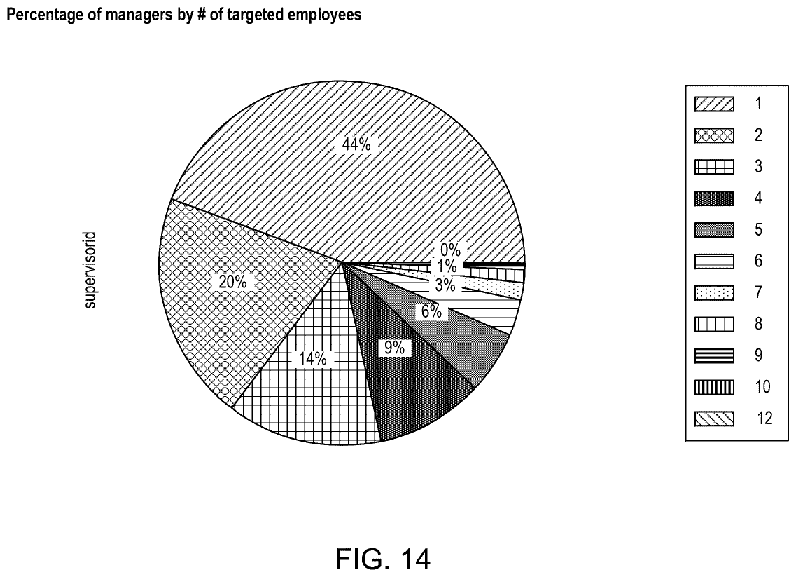

Finally, the criteria that the data processing system 102 can use, target users of at least one computing device 104 for vacation nudge in this POC are vac_exp_risk is high, days since last vacation >60, days till next planned vacation >30, float holiday balance+vacation balance >40 hours, and employee tenure >=1 year. The managers of targeted users of at least one computing device 104 will get manager-level nudges to highlight their team's status. Running analysis with data on 2023-04-01, the data processing system 102 can target 3.6 k users of at least one computing device 104 and 1.5 k managers. The following charts show vacation-related metrics of targeted users of at least one computing device 104 and non-targeted users of at least one computing device 104. FIG. 14 is an illustrative example of a graph 1400 associated with a use case. Things emerging in this POC that the data processing system 102 can need to consider during future iterations:

Different organization/teams may have different metrics to target about vacation taking. Vacation expiration risks only work for companies that have annual capped vacation hours. In addition, it may not be the best indicator to measure ‘who is not taking enough vacation’. Because it is prone to nudge people in the category of ‘having too much vacation than they need’. Metric such as ‘vacation time taken in the last 365 days’ may be a more direct measurement to judge ‘whether people are taking enough vacation’ to achieve life-work balance.

In the POC, the data processing system 102 does not send nudges to users of at least one computing device 104 with tenure <1 year. The data processing system 102 can reconsider this criteria in future and come up a way to help short-term users of at least one computing device 104 and new users of at least one computing device 104 to achieve life-work balance.

Writing an appropriate and effective communication message takes a lot of time. Nudge system will have a message library to make research-backed and expertise-curated contents available to more users. Furthermore, when sending messages out to grab attention and triggering an action is also a complicated question. Do the data processing system 102 can want to send the messages when people are less busy? Do the data processing system 102 can want to send the messages when people are more likely to take action? How can the data processing system 102 know when a person is less busy or more likely to take action for a specific nudge?

With the increasing data available through SGDP/EDP and the development of AI technologies, the Nudge Generator has a lot to offer to help HR practitioner create more effective messages, and deliver them at the right time. In this nudge vacation POC v0, the data processing system 102 can showcase two features that would differentiate this platform. In future iterations, more features such as user engagement analysis/prediction, AI powered writing assistance would be considered. Personalized messages have been proven to be more effective in driving action: Emails with personalized email subject lines are opened more by a margin of 29%-50% in marketing research. Personalized ‘calls to action’ convert 202% better than default or standard calls to action.

With the support from EDP, the Nudge Generator would allow more dynamic fields to be embedded in messages. Users would have more flexibility to customize messages to be personal, and even use these dynamic fields in define the timing when certain messages are applicable. An example message using the template and the prompt can be “‘You work hard, you should play hard too! It has been more than 79 days since your last vacation. Plan some play-time off. As of 2023-04-01, you have a remaining balance of 117.0 hours in float holidays and vacations. Work-life balance is a priority in. The data processing system 102 can really want our users of at least one computing device 104 to take their benefits—it's yours to take and the data processing system 102 can hope you enjoy it. You have accrued 107.7 hours in float and vacation time. As you grow older, you learn a few things. One of them is to actually take the time you've allotted for vacation.”

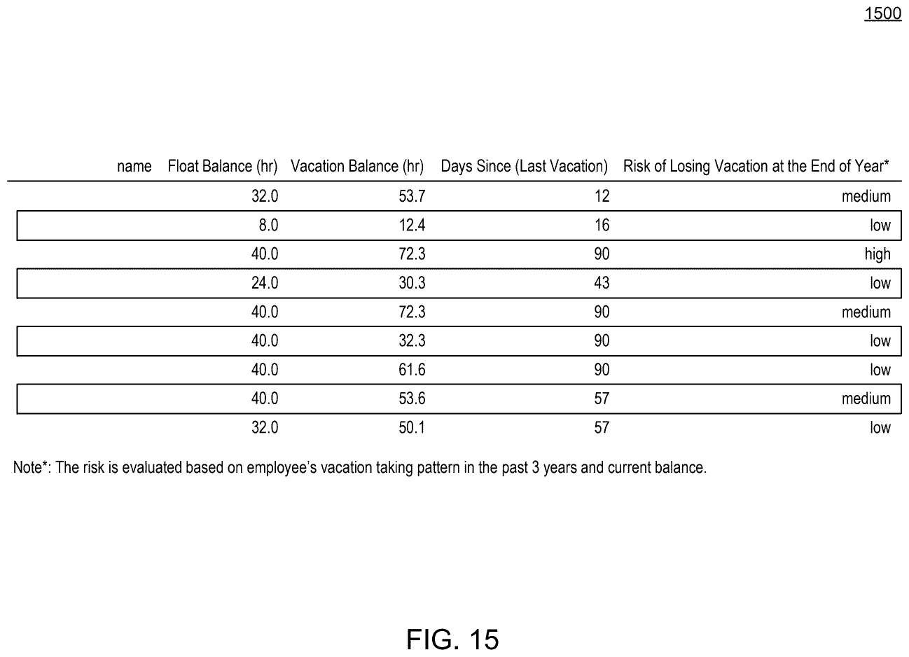

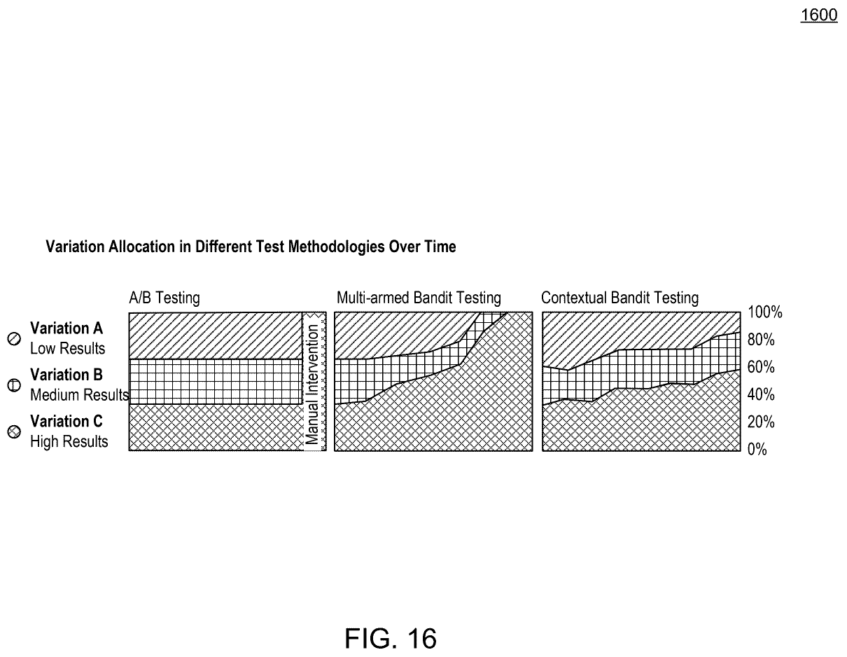

Experimentation has seen revolutionary success in marketing and has gained increasing attention in the HR domain. Classic testing frameworks, such as A/B testing, are easy to understand and can be set up to test several potential messages and iteratively help users tweak verbiage. A more advanced framework, such as Contextual Multi-armed Bandit (MAB), can find optimal messages faster and learn and adapt to the context-based optimality. FIG. 15 is an illustrative example of total elapsed times 1500. The POC uses Contextual CAB to optimize employee messages selection. The data processing system 102 can have five messages' options. All eligible messages will be selected with equal chances at first. Over time, the data processing system 102 can continuously train the model by collecting feedback data (whether someone submits PTO after clicking the message). The more effective a message is, the bigger chance it will be selected during the next round. The data processing system 102 can use message delivery month and employee information (e.g. job title_, tenure_band) as context, so that the CAB framework can optimize message selection conditional on these factors. FIG. 16 is an illustrative example of testing for the computer model according to an illustrative embodiment 1600.

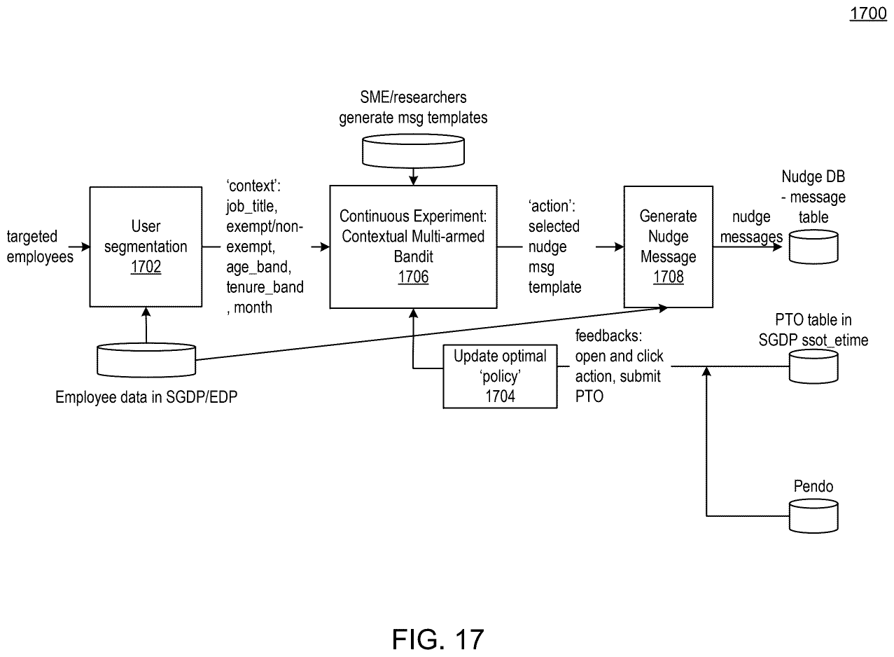

FIG. 17 is an illustrative example of a process 1700 for the computer model 118. The data processing system can perform each of the steps in the process 1700. Under the process 1700, at step 1702, user segmentation can be performed using employee data stored in SGDP/EDP to divide targeted users of at least one computing device 104 into groups based on defined attributes. Segmentation can be carried out using values such as job title, exempt or non-exempt status, age band, tenure band, and month. The segmentation output can be generated by applying segmentation rules across the employee dataset and forwarding the resulting segments to step 1706.

At step 1704, update optimal policy can be performed to adjust decision parameters used by the experimental selection process. The policy updates can be based on feedback data such as message opens, click actions, and submissions of PTO requests. The recalculated policy values can be produced by reading interaction records from PTO tables and other feedback sources, modifying selection weights or logic, and providing the updated policy data to step 1706.

At step 1706, a continuous experiment contextual multi-armed bandit processing can be executed to select an appropriate nudge message template for a given employee segment. The decision process can use segmentation data from step 1702 and policy values from step 1704 to evaluate available templates. The selected template can be identified by calculating expected performance measures for each option and sending the chosen template to step 1708.

At step 1708, the data processing system 102 can generate a complete nudge message for delivery. The selected template from step 1706 can be populated with current parameter data relating to the targeted employee. The message payload can be assembled by merging static template content with dynamic fields, validating the message format, and writing the completed message into the nudge DB message table for subsequent distribution.

In a non-limiting example for vacationing, the data processing system 102 can analyze the client US users of at least one computing device 104 vacation data in 2021 and 2022 to answer questions, including “What percentage of people lose vacation time and how many hours”, What are the typical patterns of people taking vacation/floating holidays? Does the pattern change with job type, location”, “What's the typical planning vacation horizon? How early do people submit PTO ahead of actual vacation time.”

The data processing system 102 can estimate that >four percent of users of at least one computing device 104 do not record any vacation hours/PTOs in the system. For those who recorded vacation hours ˜thirty percent lost more than 4 hours vacation time in 2022, ˜ten percent of accrued vacation time expired. Vacation patterns can change from year to year. For example, among those who have expired vacations in 2021, fifty-eight percent lost vacation time in 2022. Friday is the most popular day to take vacation. December is the most popular month to take time off Seventy-nine percent of vacations overlap with or next to weekends; nineteen percent of vacations overlap with or next to holidays. Exempt and non-exempt, job-type are correlated with different vacation patterns. In some instances, the data processing system 102 can are not able to observe impacts of permissive vs non-permissive leave policy, country, etc. However, the factors described herein can influence vacation patterns. Fifty percent of PTO requests are submitted at least fifteen days head of vacation start dates. Seventy percent of PTO requests are submitted at least one week ahead of time. 3.7% PTO requests are submitted after vacation starts. Median (days between two vacations) ˜twenty-three days. Fifty-two percent of people have at least one time in a year with days_since_last_vac>90. Eighty-three percent of people have at least one time in a year with days_since_last_vac>60 days.

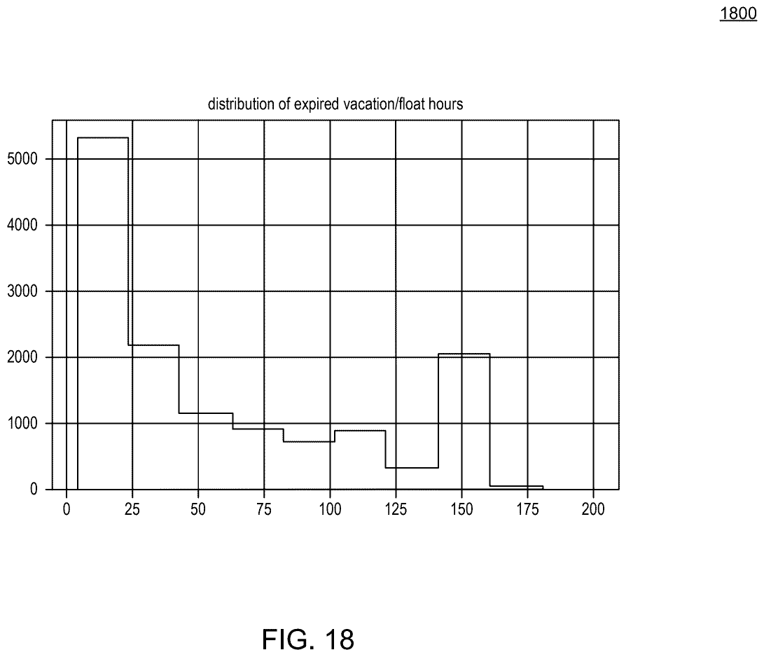

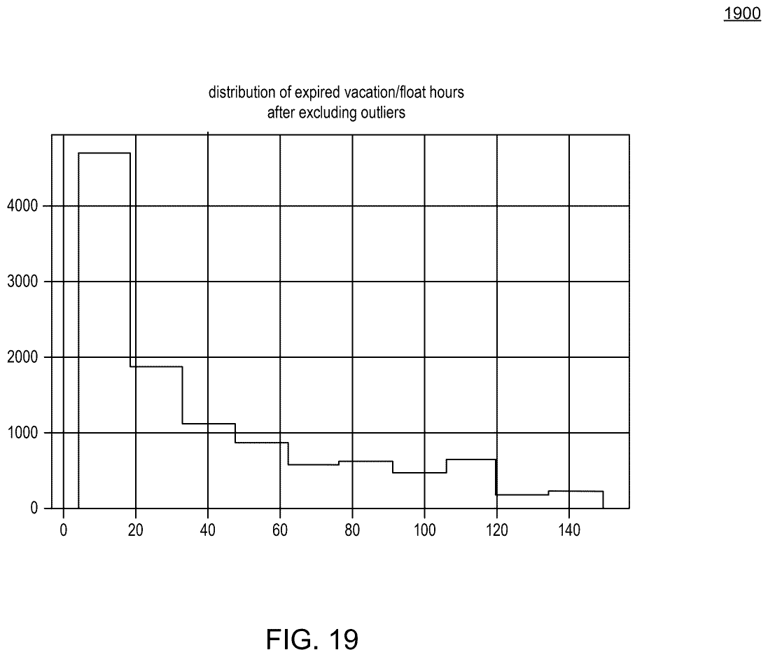

FIGS. 18-23 are an illustrative example of various statistics associated with the use case of the framework. Lost vacation time data source records in ssot_blue_etime_prod.accrualtran. The data covers forty thousand users of at least one computing device 104 in the US that have vacation accrued during this period. Finding that over thirteen thousand people lost more than four hours vacation/float time in 2022, that accounts for ˜33.2% of users of at least one computing device 104 in the analysis. Total lost vacation hours sum up to seven hundred and eighty hours, equivalent to 14.8% of accrued vacation/float hours. Among the users of at least one computing device 104 who lost more than four hours of vacation hours, forty percent lost <=24 hours, fourteen percent lost >=150 hours. For the 1.9 k (˜¹⁴% of 13.4 k, ˜5% of 40 k) users of at least one computing device 104 who lose >=150 hours in 2022, ninety percent of them don't have any record of taking vacation. The users of at least one computing device 104 might not use PTO requests to record vacation times as shown in the graph 1800 depicted in FIG. 18. After excluding people who lost>150 hours from the dataset, 11.5 k people (˜30%) lost more than 4 hours vacation/float time. Total lost vacation hours sum up to ˜450 k hours, equivalent to 9.7% of accrued vacation/float hours as shown in the graph 1900 depicted in FIG. 19.

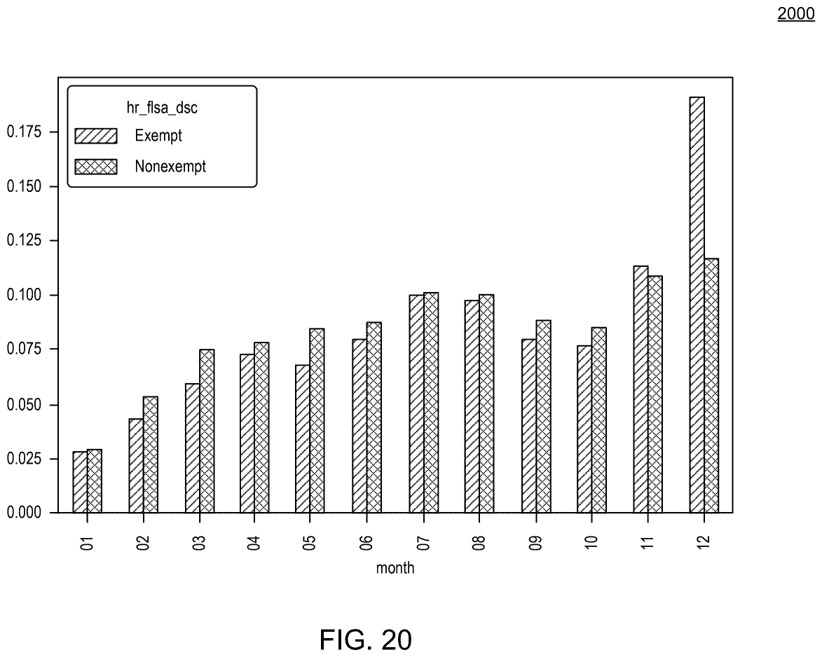

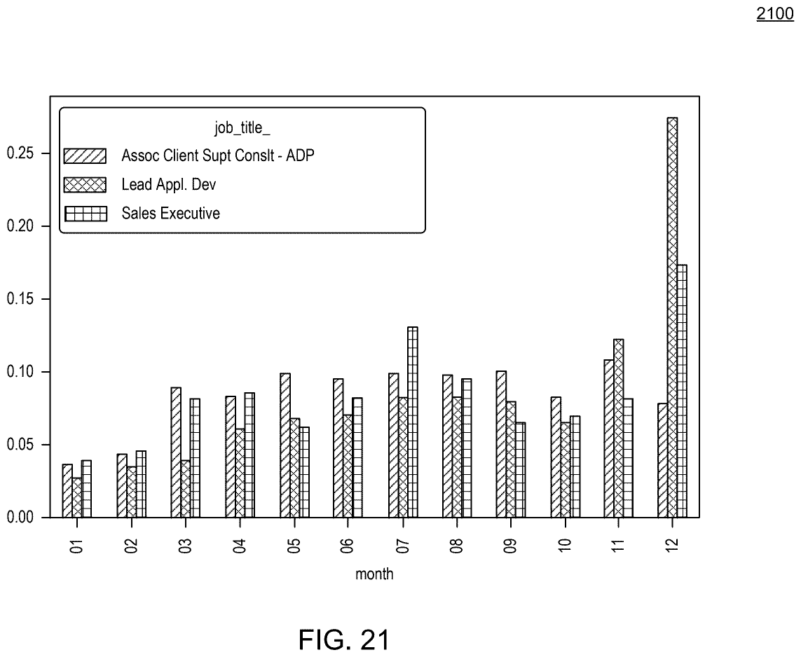

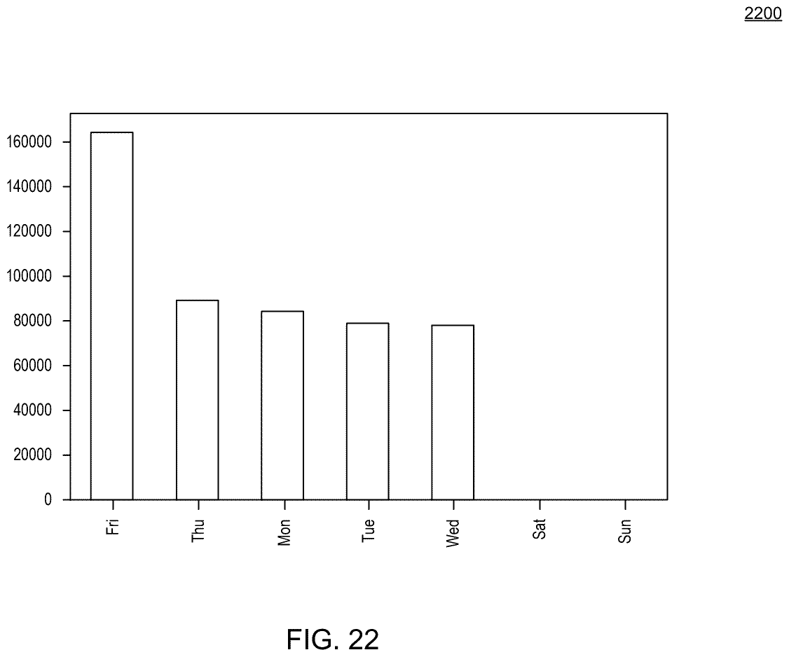

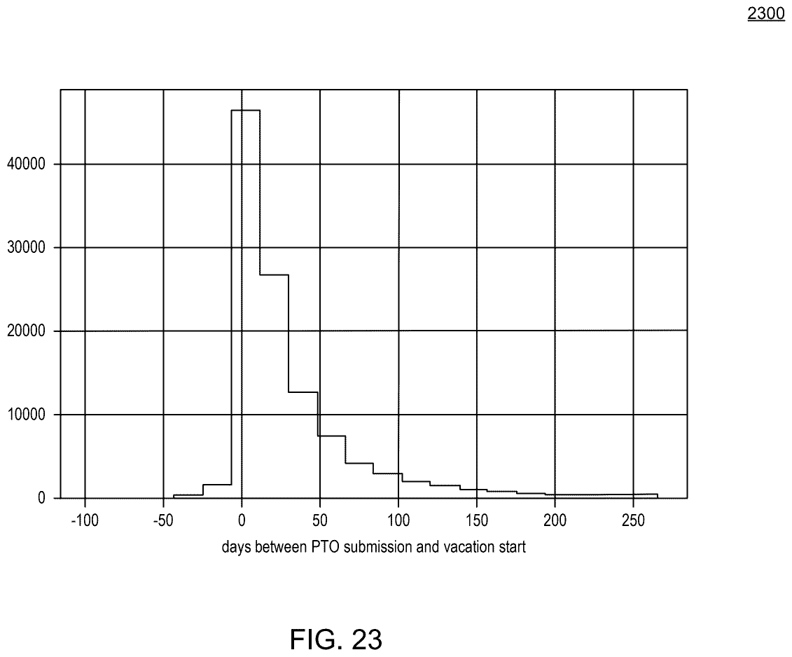

Lost vacation time a multiple year analysis data source is from records inssot_blue_etime_prod.accrualtran in 2021 and 2022. Only users of at least one computing device 104 that have records in both years are used in the analysis. Findings are correlated with people's vacation pattern in different years are correlated. Including corr(lost_HR_2021′, ‘lost_HR_2022)=0.55, of those who lost >=4 hours in 2021, 58% also lost >=4=hours in 2022, vacation patterns change slowly from year to year. Vacation time pattern of when and how long people can vacation data source are records in tables ssot_blue_etime_prod.accrualtran in 2022, joined with employee information data in us_east_1_prd_ds_blue_landing_base.employee_base_monthly. Only users of at least one computing device 104 who are in the dataset for the whole 2022 will be included in the analysis. Findings include exempt vs non-exempt users of at least one computing device 104 having different vacation patterns, as shown in the graph 2000 depicted in FIG. 20. Job-type is a factor influencing vacation patterns. For example, Associate Client Support consultant can take vacation more evenly across month, software engineers take more time off in Dec. as shown in the graph 2100 of FIG. 21. ‘Sales Executive’ and ‘Lead Appl. Developers are all exempt, ‘Assoc Client Supt Consultant-’ are all nonexempt. Friday is the most popular day to take vacation. 79% of vacations overlap with or next to weekends; 19% vacations overlap with or next to holidays as shown in the graph 2200 of FIG. 22. PTO requests are submitted at least 14 days head of vacation start. 67% PTO requests are submitted at least 1 week ahead of time. 3.7% PTO requests are submitted after vacation starts as shown in the graph 2300 of FIG. 23.

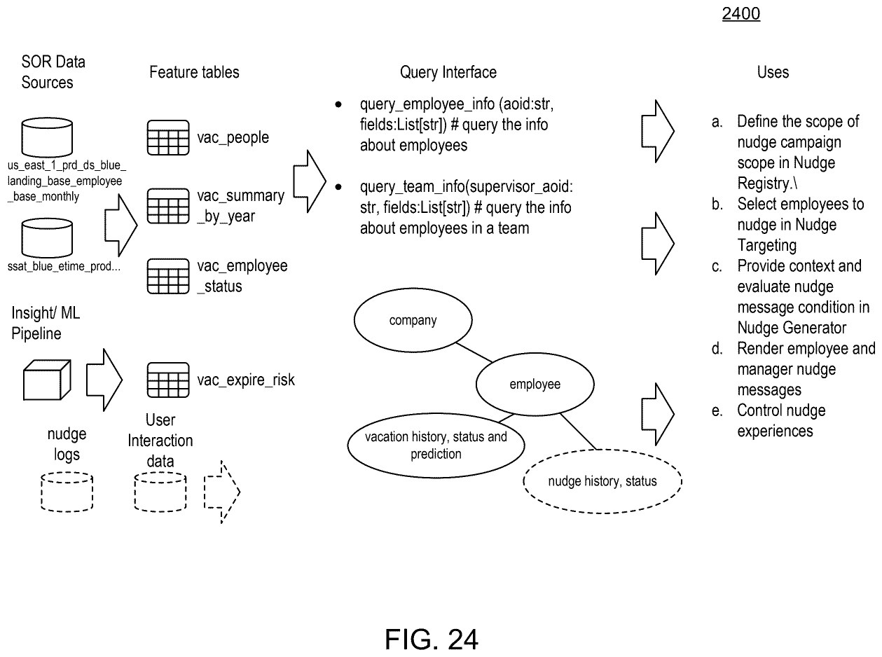

FIG. 24 is an illustrative example of data 2400 (e.g., eTime data) used by the computer model 118 of the framework. The data can be gathered from a plurality of sources (e.g., databases) as shown in FIG. 24. The data processing system 102 can create feature tables for the eTime data 2400 since, eTime tables are normalized (e.g., plurality of joins and Structured Query Language (SQL). The eTime tables can include an ID to identify users of at least one computing device 104 and mappings to that downstream applications. The eTime tables can include a plurality of feature tables. For example, a first feature table can be vac_summary_by_year. The schema for vac_summary_by_year can be:

$$root \text{\textbar --} year : string ( nullable = true ) \text{\textbar --} ooid : string ( nullable = true ) \text{\textbar --} a oid : string ( nullable = true ) \text{\textbar --} person id : long ( nullable = true ) \text{\textbar --} taken : double ( nullable = true ) \text{\textbar --} earned : double ( nullable = true ) \text{\textbar --} lost\_float : double ( nullable = true ) \text{\textbar --} lost\_vac : double ( nullable = true ) \text{\textbar --} lost : double ( nullable = true ) \text{\textbar --} taken\_ 01 : double ( nullable = true ) \text{\textbar --} taken\_ 02 : double ( nullable = true ) \text{\textbar --} taken\_ 03 : double ( nullable = true ) \text{\textbar --} taken\_ 04 : double ( nullable = true ) \text{\textbar --} taken\_ 05 : double ( nullable = true ) \text{\textbar --} taken\_ 06 : double ( nullable = true ) \text{\textbar --} taken\_ 07 :$$

$$double ( nullable = true ) \text{\textbar --} taken\_ 08 : double ( nullable = true ) \text{\textbar --} taken\_ 09 : double ( nullable = true ) \text{\textbar --} taken\_ 10 : double ( nullable = true ) \text{\textbar --} taken\_ 11 : double ( nullable = true ) \text{\textbar --} taken\_ 12 : double ( nullable = true ) \text{\textbar --} earned\_ 01 : double ( nullable = true ) \text{\textbar --} earned\_ 02 : double ( nullable = true ) \text{\textbar --} earned\_ 03 : double ( nullable = true ) \text{\textbar --} earned\_ 04 : double ( nullable = true ) \text{\textbar --} earned\_ 05 : double ( nullable = true ) \text{\textbar --} earned\_ 06 : double ( nullable = true ) \text{\textbar --} earned\_ 07 : double ( nullable = true ) \text{\textbar --} earned\_ 08 : double ( nullable = true ) \text{\textbar --} earned\_ 09 : double ( nullable = true ) \text{\textbar --} earned\_ 10 : double ( nullable = true ) \text{\textbar --} earned\_ 11 : double ( nullable = true ) \vert -- earned\_ 12 : double ( nullable = true )$$

In another example, a second feature table can be vac_people that stores employee's org and employee profile from the latest partition of employee monthly, inner joined with eTime personal data (e.g. supervisor, full name, accrual profile) effective on the specified ‘report_date’. The schema for vac_people can be:

$$root \text{\textbar --} ooid : string ( nullable = true ) \text{\textbar --} a oid : string ( nullable = true ) \text{\textbar --} ap\_employee \_status : string ( nullable = true ) \text{\textbar --} ap\_hire \_date : string ( nullable = true ) \text{\textbar --} ap\_termination \_date : string ( nullable = true ) \text{\textbar --} HR\_flsa \_dsc : string ( nullable = true ) \text{\textbar --} full\_time \_part \_time \_ : string ( nullable = true ) \text{\textbar --} HR\_eeol \_dsc : string ( nullable = true ) \text{\textbar --} home\_state \_ : string ( nullable = true ) \text{\textbar --} work\_state : string ( nullable = true ) \text{\textbar --} is\_home \_office : integer ( nullable = true ) \text{\textbar --} tenure\_ : double ( nullable = true ) \text{\textbar --} tenure\_band : string ( nullable = true ) \text{\textbar --} job\_title \_ : string ( nullable = true ) \text{\textbar --} gender\_ : string ( nullable = true ) \text{\textbar --}$$

$$marital\_status \_ : string ( nullable = true ) \text{\textbar --} a ge\_band : string ( nullable = true ) \text{\textbar --} generation\_band : string ( nullable = true ) \text{\textbar --} HR\_orgn \_cd : string ( nullable = true ) \text{\textbar --} HR\_orgn \_shrt \_dsc : string ( nullable = true ) \text{\textbar --} HR\_orgn \_lng \_dsc : string ( nullable = true ) \text{\textbar --} HR\_estab \_cd : string ( nullable = true ) \text{\textbar --} HR\_co \_cd : string ( nullable = true ) \text{\textbar --} employeeid : long ( nullable = true ) \text{\textbar --} supervisorid : long ( nullable = true ) \text{\textbar --} fullnm : string ( nullable = true ) \text{\textbar --} firstnm : string ( nullable = true ) \text{\textbar --} shortnm : string ( nullable = true ) \text{\textbar --} emp\_stat : string ( nullable = true ) \text{\textbar --} accrualprofileid : long ( nullable = true ) \text{\textbar --} ap\_name : string ( nullable = true ) \text{\textbar --} employee\_monthly \_yyymm : integer ( nullable = true ) \text{\textbar --} report\_date \text{} : date ( nullable = true ) \text{\textbar --} updated\_ts : timestamp ( nullable = true )$$

In another example, a third feature table can be vac_employee_status that stores the employee vacation balance and status, statistics such as hours taken in the past x days, calculated at the specified ‘report_date’. The schema for vac_employe_status can be:

$$root \text{\textbar --} ooid : string ( nullable = true ) \text{\textbar --} a oid : string ( nullable = true ) \text{\textbar --} person id : long ( nullable = true ) \text{\textbar --} taken : double ( nullable = true ) \text{\textbar --} earned : double ( nullable = true ) \text{\textbar --} taken\_ 01 : double ( nullable = true ) \text{\textbar --} taken\_ 02 : double ( nullable = true ) \text{\textbar --} taken\_ 03 : double ( nullable = true ) \text{\textbar --} earned\_ 01 : double ( nullable = true ) \text{\textbar --} earned\_ 02 : double ( nullable = true ) \text{\textbar --} earned\_ 03 : double ( nullable = true ) \text{\textbar --} last\_vac \text{} \_date : timestamp ( nullable = true ) \text{\textbar --} next\_vac \text{} \_date : timestamp ( nullable = true ) \text{\textbar --} days\_since \_last \_vac : long ( nullable = true ) \text{\textbar --} days\_till \_next \_vac : long ( nullable = true ) \text{\textbar --} float\_balance :$$

$$double ( nullable = true ) \text{\textbar --} vacation\_balance : double ( nullable = true ) \text{\textbar --} est\_year \_end \_balance : double ( nullable = true ) \text{\textbar --} to\_be \_ \text{} earned : double ( nullable = true ) \text{\textbar --} plan\_vacation \_to \_take : double ( nullable = true ) \text{\textbar --} plan\_float \_to \_take : double ( nullable = true ) \text{\textbar --} taken\_past \_ 60 \_d : double ( nullable = true ) \text{\textbar --} taken\_past \_ 90 \_d : double ( nullable = true ) \text{\textbar --} taken\_past \_ 120 \_d : double ( nullable = true ) \text{\textbar --} taken\_past \_ 180 \_d : double ( nullable = true ) \text{\textbar --} taken\_past \_ 365 \text{} \_d : double ( nullable = true ) \text{\textbar --} report\_date : date ( nullable = true$$

In another example, a fourth feature table can be vac_expire_risk that stores the features and predictions of vacation expiration risk. The schema for vac_expire_risk can be:

$$root \text{\textbar --} ooid : string ( nullable = true ) \text{\textbar --} a oid : string ( nullable = true ) \text{\textbar --} k\_ 1 : double ( nullable = true ) \text{\textbar --} k\_ 2 \text{} : double ( nullable = true ) \text{\textbar --} k\_ 3 : double ( nullable = true ) \text{\textbar --} taken\_last \_year : double ( nullable = true ) \text{\textbar --} float\_balance : double ( nullable = true ) \text{\textbar --} vacation\_balance : double ( nullable = true ) \text{\textbar --} est\_year \_end \_balance : double ( nullable = true ) \text{\textbar --} report\_date : date ( nullable = true ) \text{\textbar --} month : long ( nullable = true ) \text{\textbar --} vac\_exp \_risk : double ( nullable = true ) \text{\textbar --} vac\_exp \_risk \_cat : string ( nullable = true )$$

The computer model can determine the risk of whether a US employee would have more than 4 hours vacation expired at the end of year. This prediction enables computer models to target persons with a high risk of vacation expiration in the early months of a year. So that the data processing system 102 can send nudges to encourage them to take more time off. The data processing system 102 can use client data in ssot_blue_etime_prod to develop a dataset for model training and testing. The model features can be established from monthly snapshots of US employee vacation data in 2021-2024, while labels are derived from the annual expiration events. Features include the month of the data snapshot. For example, if the data snapshot is 2024-04-01, month will be 4, k_1: 1 if the employee lost more than 4 hours of vacation or float holiday time at the end of last year, otherwise 0, k_2: 1 if the employee lost more than 4 hours of vacation or float holiday time at the end of last year, otherwise 0, k_3: 1 if the employee lost more than 4 hours of vacation or float holiday time at the end of last year, otherwise 0, est year-end balance: estimated balance at the end of year snapshot float holiday balance+snapshot vacation time balance+hours to earn from snapshot date till Dec 31st—hours taken last year from snapshot date till Dec 31st, taken last year: vacation time taken in the last year in hours, float balance: snapshot float time balance in hours, vacation balance: snapshot vacation time balance in hours. There can be ˜558 k records in the dataset. ⅔ is used in training and ⅓ is testing. The split is random.

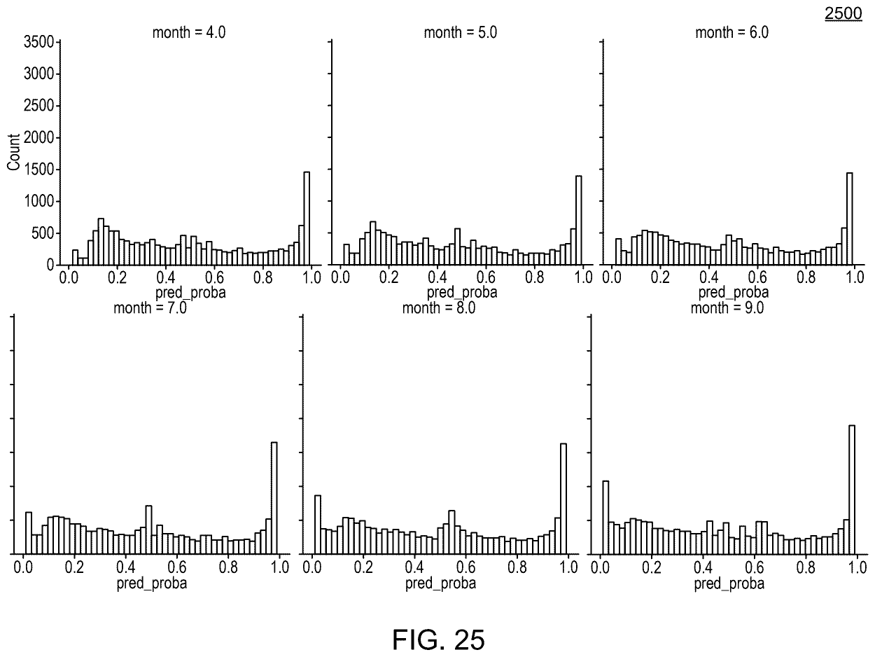

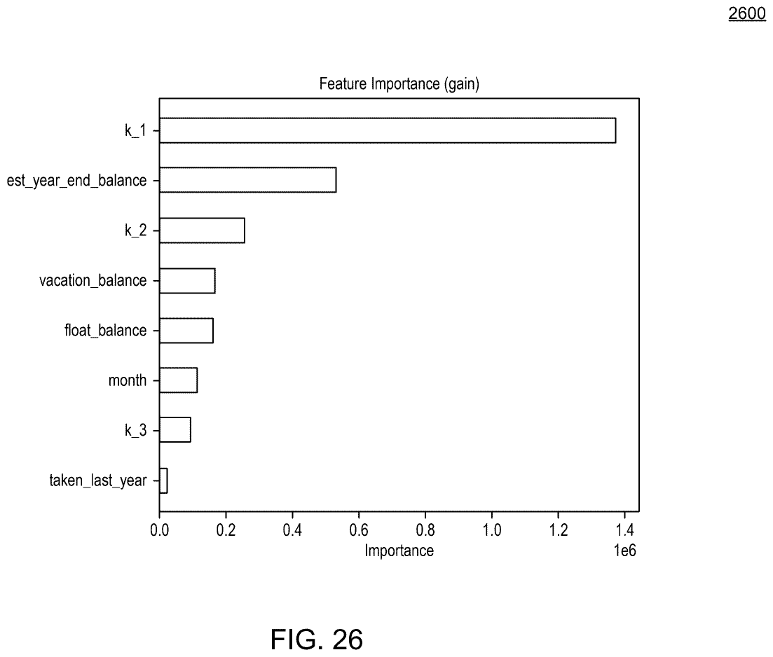

A lightgbm binary classification model is built with the following parameters are boosting_type=‘dart’,num_leaves=31, max_depth=−1, learning_rate=0.1, n_estimators=200, subsample_for_bin=200000, objective=None, class weight=None, min_split_gain=0.0, min_child_weight=0.001, min_child_samples=20, subsample=1.0, subsample_freq=0, colsample_bytree=1.0, reg_alpha=0.0, reg_lambda=0.0, random_state=42, n_jobs=None, importance_type=‘split’. Parameters in bold are specifically defined, while all others are default. Testing dataset AUC ˜0.88. Train Accuracy ˜0.8 and Testing Accuracy ˜0.8. The below table shows that prediction accuracy improves when time approaches the end of year, and when the data processing system 102 can have at least one year of vacation taking data for the employee. Testing accuracy can occur based on snapshot time and when the employee joined. FIG. 25 depicts an illustrative example of a plurality of graphs 2500 of statistics associated with the use case of the framework. FIG. 26 depicts an illustrative example of a graph 2600 of statistics associated with the use case of the framework. By design, the data processing system 102 can expect to see view count and click-through-rate drop with time, because one the mobile action card within the application can disappear if the data processing system detects one or more clicks. If a person has the habit of clicking ‘action card’ he/she would have clicked it in the first few times seeing it. Therefore, the viewers towards the end of the nudge duration are more likely to be the users who don't have the habit of clicking ‘action card’ it's easy to observe from data that user interactions have weekly patterns. User Interaction can be most active on Thursday.

Use it or lose it nudge was sent to 1155 US associates in GPT &amp; HR on Sept 25 via the application. Randomly selected 366 recipients to invite to give feedback via self-report survey; 69 responded (19% response rate). Burnout nudge sent the following. 183 managers of US associates in GPT &amp; HR on Sept 25 via Webex from A.V.A for HR. 175 invited to give feedback via survey; 34 responded (19% RR). 42 US associates in GPT &amp; HR on Sept 27 via the application. View/click metrics from both associate nudges combined with feedback from the “use it or lose it” survey suggest the associate nudges sent via the mobile application got low engagement. By comparison, 91% of managers that responded to the feedback survey reported seeing the nudge in Webex. For the future, the data processing system 102 can maintain the associate nudges up on the mobile application for longer or use a different channel. Despite low visibility, results show associates who did see the use it or lose it nudge were more likely to schedule PTO. Of the 91 recipients who clicked the nudge, 55% scheduled PTO after receiving it. In comparison, 47% of those who opened the application scheduled PTO vs. 43% of those who didn't open the application. Associates who recalled seeing the nudge also reported they found it very helpful (4.32/5 avg helpfulness rating). It is harder to draw conclusions on the effectiveness of burnout nudge given small sample size, low visibility and poor response rate to the associate feedback survey.

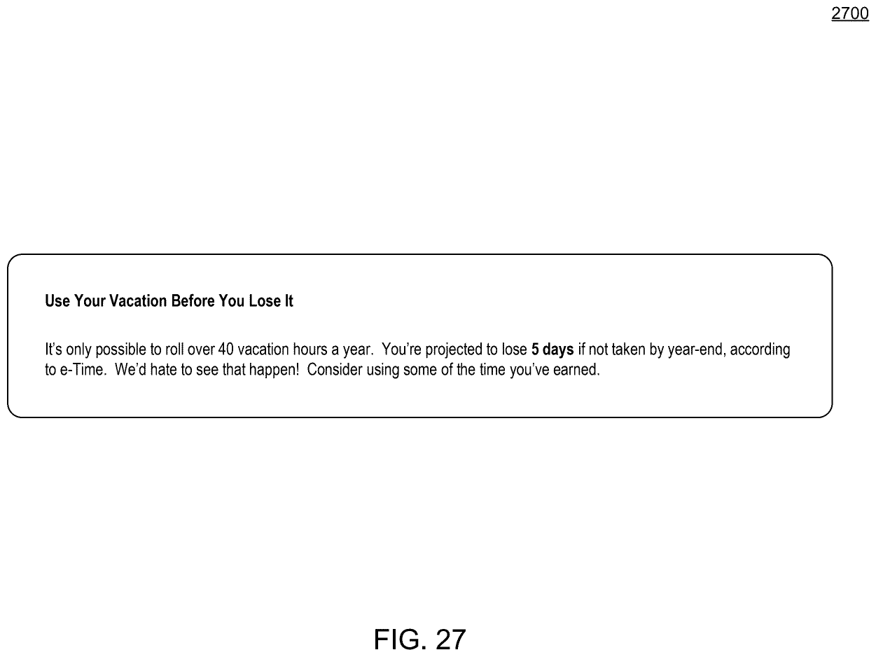

FIGS. 27-30 are illustrative example of messages generated by the computer model case of the framework. Each message can be personalized for the computing device 104 in accordance with the request of the administrative computing device 104. FIG. 27 illustrates an example user message alerting an individual to the potential loss of accrued vacation hours if not used by a specified date. FIG. 27 shows how a pre-defined message template can be populated with specific data to convey the condition, serving as an example 2700 of the type of notifications generated by the system to prompt user action.

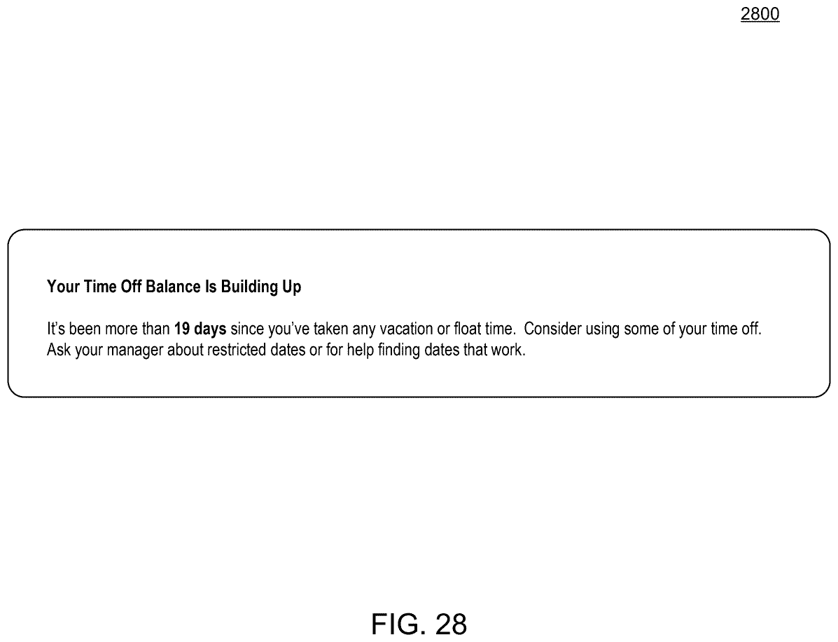

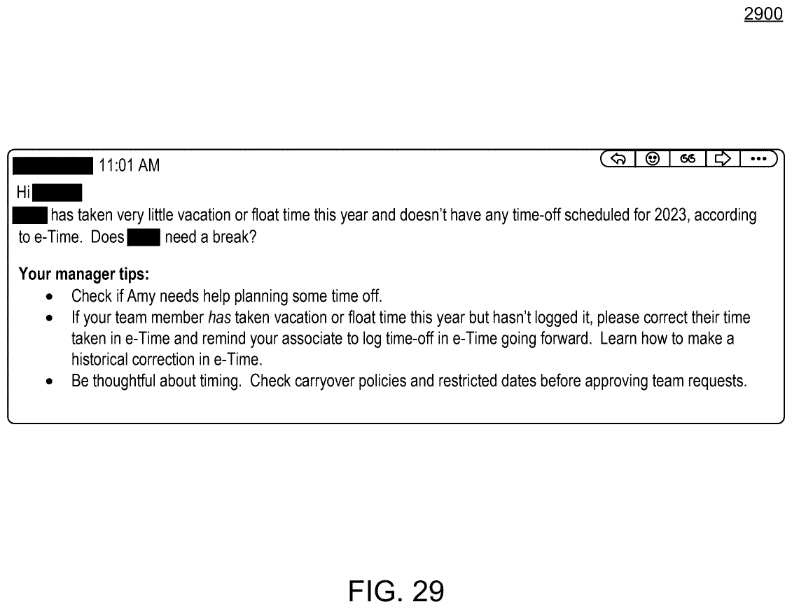

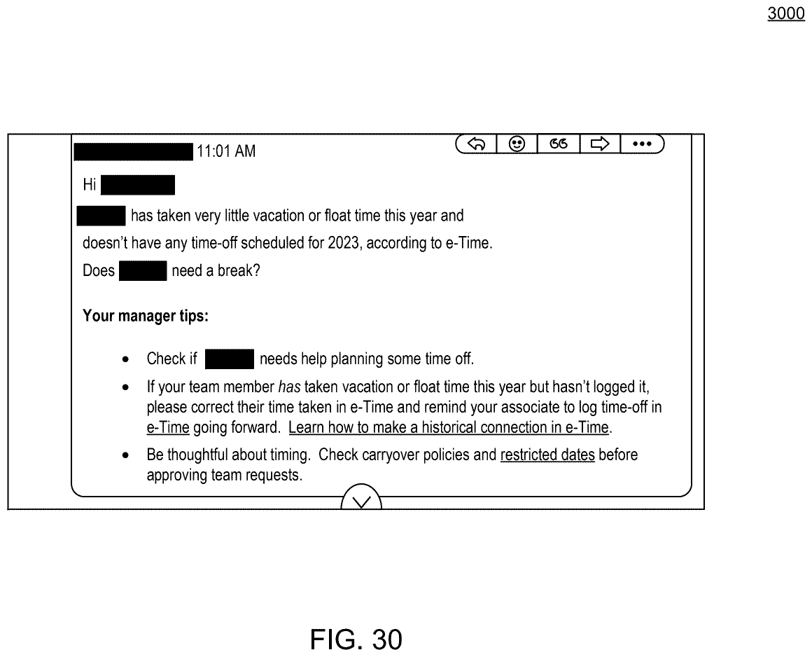

FIG. 28 illustrates an example user message advising an individual to take vacation or float time based on the number of days since their last recorded leave. FIG. 28 shows the insertion of current usage data into a stored template, providing a targeted reminder 2800 as an example of system-generated notifications. FIG. 29 illustrates an example manager-level message 2900 identifying an employee with minimal vacation usage and no scheduled time off. FIG. 29 shows a template designed for managerial audiences populated with employee-specific details, as an example of communications intended for supervisory follow-up. FIG. 30 illustrates another example manager-level message 3000 highlighting an employee who does not have upcoming vacation scheduled. FIG. 30 shows how the system delivers context-specific information in a managerial template, serving as an example of notifications for encouraging review or corrective action.

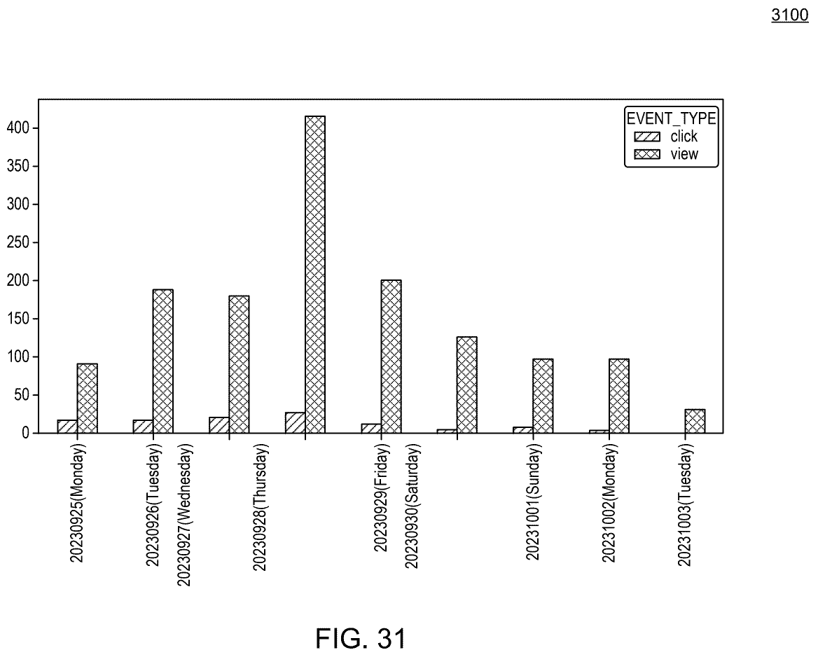

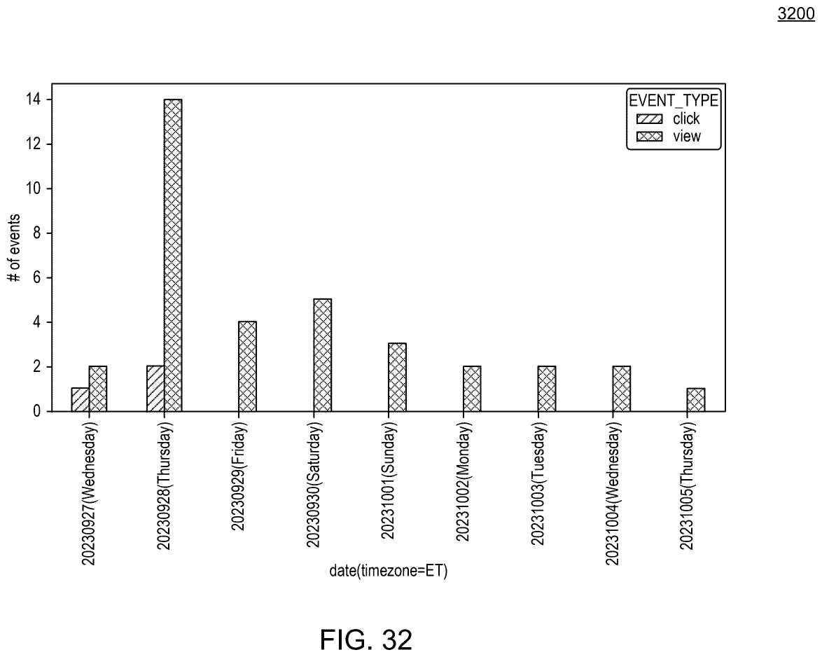

FIGS. 31-32 are illustrative example of various statistics associated with the use case of the framework. FIG. 31 illustrates example statistics 3100 related to user interactions with displayed notifications, including counts of views and clicks over several days. FIG. 31 shows how engagement data can be tracked and displayed, serving as an example of system-generated metrics for assessing notification performance. FIG. 32 illustrates additional example statistics 3200 summarizing views and clicks for displayed notifications over a specified period. FIG. 32 shows how user engagement information is aggregated and presented, serving as an example of how the system measures communication effectiveness.

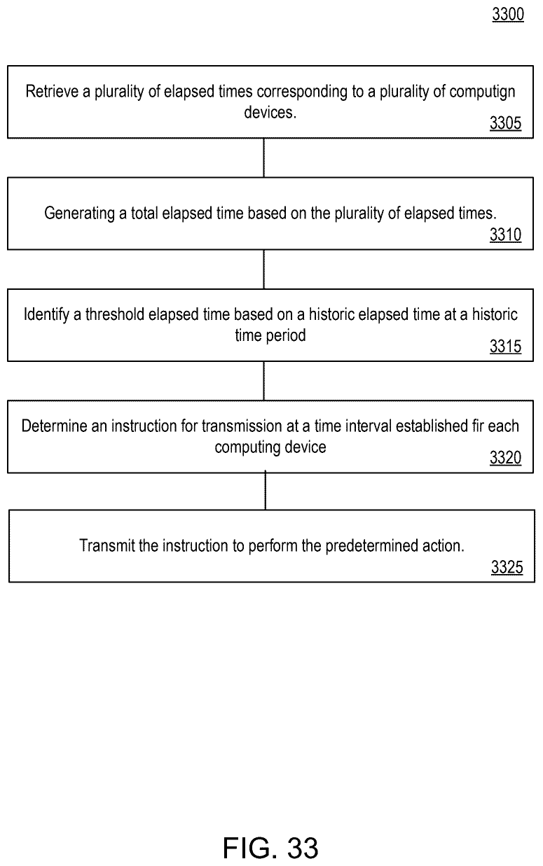

FIG. 33 depicts a method 3300 for a framework for message generation. The method 3300 can be performed by, using, or for a system 100 or a computing device 104. The method 3300 can include retrieving a plurality of elapsed times at ACT 3305. The method 3300 can include generating a total elapsed time based on each elapsed time in the plurality of elapsed times at ACT 3310. The method 3300 can include determining that the total elapsed time satisfies a threshold elapsed time at ACT 3315. The method 3300 can include generating instructions for transmission to at least one administrative computing device at ACT 3320. At act 3325, the method can include transmitting the instruction to perform the predetermined action.

In some examples, a structured definition containing metadata can be used for a specific detection or notification scenario. Attributes such as title, description, version, business unit, and source system can be stored to identify and configure a particular operational or compliance use case. Such technical solutions can maintain clear, queryable records of the use cases supported by the systems and methods described herein.

In some examples, a configuration structure can define when a detection or notification process is executed. Elements such as calendar settings, skip dates, jitter values, and time zones can be stored for precise control of timing. Such technical solutions can enable the systems and methods described herein to reliably schedule processes across environments.

In some examples, a definition list for triggers can be based on detected events rather than scheduled times. Unique event identifiers and related configurations can be stored and referenced to initiate processes. Such technical solutions can enable the systems and methods described herein to support real-time responsiveness to specific occurrences.

In some examples, query definitions can be stored for retrieving the data needed to detect anomalies or populate notifications. SQL commands, parameters for different environments, database connections, and output schemas can be organized in a central repository. Such technical solutions can enable the systems and methods described herein to maintain a centralized, adaptable data retrieval layer.

In some examples, a catalog of external or internal endpoints can be maintained for delivering messages or instructions once created. Endpoint identifiers, methods, headers, URLs, and request templates can be stored for consistent use. Such technical solutions can enable the systems and methods described herein to manage multiple delivery channels in a unified way.

In some examples, a mapping can be maintained between retrieved data fields and the placeholders used in templates. Source fields from queries can be linked to destination fields in message creation. Such technical solutions can enable the systems and methods described herein to ensure accurate and consistent data population.

In some examples, a complete configuration can link triggers, data targets, delivery channels, and content templates. Each configuration can be identified along with its timing, targets, and content specifications. Such technical solutions can enable the systems and methods described herein to define and execute full end-to-end processes.

The foregoing examples have been provided merely for the purpose of explanation and are in no way to be construed as limiting of the technology described herein. While aspects of the technology described herein have been described with reference to an exemplary embodiment, it is understood that the words which have been used herein are words of description and illustration, rather than words of limitation. Changes can be made, within the purview of the appended claims, as presently stated and as amended, without departing from the scope and spirit of the technology described herein in its aspects. Although aspects of the technical solution have been described herein with reference to particular means, materials and embodiments, the present technical solution is not intended to be limited to the particulars described herein; rather, the present technical solution extends to all functionally equivalent structures, methods and uses, such as are within the scope of the appended claims.

The subject matter and the operations described in this specification can be implemented in digital electronic circuitry, or in computer software, firmware, or hardware, including the structures described in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively, or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device,” “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing, and grid computing infrastructures.

A computer program (also known as a program, software, software application, application, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media, and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that can include a back end component, e.g., as a data server, or that can include a middleware component, e.g., an application server, or that can include a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts, and those elements can be combined in other ways to accomplish the same objectives. Acts, elements, and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently described systems or methods, their components, acts, or elements to single or plural configurations. References to any act or element being based on any information, act or element can include implementations where the act or element is based at least in part on any information, act, or element.

Any implementation described herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations described herein.

References to “or” can be construed as inclusive so that any terms described using “or” can indicate any of a single, more than one, and all of the described terms. References to at least one of a conjunctive list of terms can be construed as an inclusive OR to indicate any of a single, more than one, and all of the described terms. For example, a reference to “at least one of ‘A’ and ‘B’” can include only ‘A,’ only ‘B,’ as well as both ‘A’ and ‘B.’ Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as substitutions, changes and omissions can be made in the design, operating conditions and arrangement of the described elements and operations without departing from the scope of the present disclosure.

What is claimed is:

1. A system, comprising:
one or more processors, coupled with memory, to:
retrieve, from a database at a time period, a plurality of elapsed times corresponding to a plurality of computing devices executing respective instances of an application, each elapsed time based on detection, at a prior time period, of an absence of at least one computing device executing a predetermined action within the respective instance of the application;
generate, via a computing operation, a total elapsed time for the time period based on the plurality of elapsed times;
identify, via the computing operation, a threshold elapsed time based on a historic elapsed time at a historic time period and one or more parameters causing an increase in the historic elapsed time at the at least one computing device from the database, the historic time period preceding the time period;
responsive to the total elapsed time being greater than or equal to the threshold elapsed time, determine, via execution of a computer model, an instruction for transmission at a time interval established for each computing device based on the one or more parameters; and
transmit, to the at least one computing device at the time interval, the instruction to perform the predetermined action, the instruction configured to cause the at least one computing device to display a notification indicating each of the one or more parameters causing the increase in the total elapsed time and causing the absence of the predetermined action.

2. The system of claim 1, wherein the one or more processors further:
determine a delta between the total elapsed time and the historic elapsed time.

3. The system of claim 1, wherein the one or more processors further:
determine that the at least one computing device in the plurality of computing devices is associated with the one or more parameters based on the absence of executing the predetermined action.

4. The system of claim 3, wherein the one or more processors further:
retrieve data from the database associated with the at least one computing device; and
compare the data against criteria that indicate the one or more parameters.

5. The system of claim 4, wherein the one or more processors further:
generate a profile for the at least one computing device using the application executing on the at least one computing device, the application including information associated with a user of the at least one computing device.

6. The system of claim 5, wherein the one or more processors further:
monitor an administrative computing device and the profile of the at least one computing device to detect a modification to the information associated with the user of the at least one computing device;
generate, using the computer model, an instruction for transmission at the to the at least one computing device based on the detection of the modification at the administrative device, the instruction causing the at least one computing device to display a prompt to address the modification;
verify that an input to a displayed message from the at least one computing device addresses the modification; and
responsive to a successful verification of the input, prevent the computer model from generating a subsequent instruction.

7. The system of claim 6, wherein the one or more processors further generate, using the computer model, a subsequent instruction for transmission to the at least one computing device and the administrative device, in response to an unsuccessful verification of the input.

8. The system of claim 5, wherein the one or more processors further:
identify a template according to the criteria of the one or more parameters causing the increase in the total elapsed time;
generate a prompt using the template and the profile of the at least one computing device; and
transmit the instruction including an output message based on the prompt to reduce the one or more parameters causing the increase in the total elapsed time, using the computer model.

9. The system of claim 1, wherein the one or more processors further:
select a template from a template library stored within the database by comparing a classification based on the one or more parameters to a placeholder field that indicates a type for the template, wherein the template library includes a plurality of templates and the type for each of the plurality of templates.

10. The system of claim 9, wherein the one or more processors further:
populate the placeholder field of the template with the classification by executing a second computing operation that maps the type for the template to data within a profile associated with the at least one computing device executing the application.

11. The system of claim 1, wherein the one or more processors further:
receive, from the application executing on the at least one computing device, a request to resolve the one or more parameters indicating an anomaly, the anomaly corresponding to an indicator based on at least one elapsed time, the indicator corresponding to one or more of an address discrepancy, missing verification information, missing registration data, time anomalies, or payroll modifications; and
determine whether a template library within the database includes at least one template that includes a placeholder field that maps to the anomaly by querying the template library to resolve the one or more parameters.

12. The system of claim 11, wherein the one or more processors further:
responsive to the template library including the at least one template, identify that a score for the template satisfies a threshold, the threshold indicating that a template corresponds to the at least one computing device based on data extracted from the application;
responsive to the score not satisfying the threshold, generate a second template by modifying the at least one template to include placeholder fields based on the data extracted from the application executing on the at least one computing device; and
store an association between the second template and the at least one computing device.

13. The system of claim 12, wherein the one or more processors further:
responsive to the score satisfying the threshold, store the association between the at least one template and the at least one computing device; and
provide the at least one template to the computer model to resolve the one or more parameters within the request.

14. The system of claim 11, wherein the one or more processors further:
generate, using the computer model, a template to add to the template library based on data associated with the application executing on the at least one computing device.

15. The system of claim 1, wherein the one or more processors further:
transmit, to an administrative device, a second instruction generated by the computer model, the second instruction including one or more recommendations to reduce the one or more parameters and the total elapsed time.

16. A method, comprising:
retrieving, by one or more processors from a database at a time period, a plurality of elapsed times corresponding to a plurality of computing devices executing an instance of an application, each elapsed time based on detection, at a prior time period, of an absence of at least one computing device executing a predetermined action within the instance of the application;
generating, by the one or more processors via a computing operation, a total elapsed time for the time period based on the plurality of elapsed times;
identifying, by the one or more processors via the computing operation, a threshold elapsed time based on a historic elapsed time at a historic time period and one or more parameters causing an increase in the historic elapsed time at the at least one computing device from the database, the historic time period preceding the time period;
responsive to the total elapsed time being greater than or equal to the threshold elapsed time, determining, by the one or more processors via execution of a computer model, an instruction for transmission at a time interval established for each computing device based on the one or more parameters; and
transmitting, by the one or more processors to the at least one computing device, the instruction to perform the predetermined action, the instruction configured to cause the at least one computing device to display a notification indicating each of the one or more parameters causing the increase in the total elapsed time and causing the absence in the predetermined action.

17. The method of claim 16, further comprising determining, by the one or more processors, a delta between the total elapsed time and the historic elapsed time.

18. The method of claim 16, further comprising determining, by the one or more processors, that the at least one computing device in the plurality of computing devices is associated with the one or more parameters based on the absence of executing the predetermined action.

19. The method of claim 18, further comprising accessing, by the one or more processors, the application executing on the at least one computing device to generate a profile for the at least one computing device by extracting information associated with a user of the at least one computing device.

20. A non-transitory computer-readable medium that stores processor-executable instructions that, when executed by one or more processors, cause the one or more processors to:
retrieve, from a database at a time period, a plurality of elapsed times corresponding to a plurality of computing devices executing an instance of an application, each elapsed time based on detection, at a prior time period, of an absence of at least one computing device executing a predetermined action within the instance of the application;
generate, via a computing operation, a total elapsed time for the time period based on the plurality of elapsed times;
identify, via the computing operation, a threshold elapsed time based on a historic elapsed time at a historic time period and one or more parameters causing an increase in the historic elapsed time at the at least one computing device from the database, the historic time period preceding the time period;
responsive to the total elapsed time being greater than or equal to the threshold elapsed time, determine, via execution of a computer model, an instruction for transmission at a time interval established for each computing device based on the one or more parameters; and
transmit, to the at least one computing device at the time interval, the instruction to perform the predetermined action, the instruction configured to cause the at least one computing device to display a notification indicating each of the one or more parameters causing the increase in the total elapsed time and causing the absence of the predetermined action.
